(19) United States
(12) Patent Application Publication
(10) Pub. No.: US 2026/0145207 A1
(43) Pub. Date: May 28, 2026

(54) Sorting Nozzle Assembly

(71) Applicant: Sortera Technologies Inc., Markle, IN (US)

(72) Inventors: Jacob John Berry, Markle, IN (US); Matthew Gevers, Markle, IN (US)

(73) Assignee: Sortera Technologies Inc., Markle, IN (US)

(21) Appl. No.: 19/399,069

(22) Filed: Nov. 24, 2025

Related U.S. Application Data
(60) Provisional application No. 63/725,119, filed on Nov. 26, 2024.

(51) Int. Cl. B07C 5/36

(52) U.S. Cl. CPC B07C 5/367

(57) ABSTRACT

A nozzle assembly with an array of nozzles that are oriented at projection angles relative to each other so that each nozzle's intended focal point on the conveyor belt more effectively diverts material pieces having different sizes, shapes, and/or masses. The array of nozzles expel or project a gaseous or liquid media from orifices formed in tips of each of the nozzles towards/against material pieces transported past the nozzle assembly based on the identification/classification of the individual material pieces as described with respect to a material handling system disclosed herein. The nozzle assembly may be designed with internal conduits for a more efficient flow of air, which increases the response time from when a pressurized air jet is actuated from a nozzle.

This application claim priority to U.S. provisional patent application Ser. No. 63/725,119, which is hereby incorporated by reference herein.

### TECHNOLOGY FIELD

The present disclosure relates in general to the sorting of objects, and in particular, to an array of nozzles for diverting objects from a moving path.

### BACKGROUND INFORMATION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Recycling has benefits for communities and for the environment, since it reduces the amount of waste sent to landfills and incinerators, conserves natural resources, increases economic security by tapping a domestic source of materials, prevents pollution by reducing the need to collect new raw materials, and saves energy.

The recycling of aluminum (Al) scrap is a very attractive proposition in that up to 95% of the energy costs associated with manufacturing can be saved when compared with the laborious extraction of the more costly primary aluminum. At the same time, the demand for aluminum is steadily increasing in markets, such as car manufacturing, because of its lightweight properties. As a result, there are certain economies available to the aluminum industry by developing a well-planned yet simple recycling plan or system. Thus, the use of recycled material would be a less expensive metal resource than a primary source of aluminum. As the amount of aluminum sold to the automotive industry (and other industries) increases, it will become increasingly beneficial to use recycled aluminum to supplement the availability of primary aluminum. Correspondingly, it is particularly desirable to efficiently sort aluminum scrap metals into alloy families, since mixed aluminum scrap of the same alloy family is more valuable to the recycling industry than that of indiscriminately mixed alloys. For example, in the blending methods used to recycle aluminum, any quantity of scrap composed of similar, or the same, alloys and of consistent quality, has more value than scrap composed of mixed aluminum alloys.

One of the challenges with the sorting of different types of objects from a conveyor system is being able to effectively divert or eject such objects having different sizes, masses, and/or shapes from the conveyor system. When utilizing pressurized nozzles (also referred to as “air jet nozzles”) for diverting an object from a conveyor belt, a pressurized air jet projected from a nozzle to blow off or divert an object of a certain size or shape may not be as effective in diverting or blowing off objects having different sizes or shapes. As an example, an nozzle may not be effective to divert an object that has a relatively flat profile when deposited onto a conveyor belt.

To consider a more specific non-limiting example, metal alloy scrap pieces resulting from pre-consumer or end-of-life (“EOL”) scrap can have considerably varying sizes, masses, and/or shapes. A single nozzle, or even a multitude of simultaneously fired nozzles, may only result in partial contact of the projected pressurized air jet on some scrap pieces due to the fact that they are smaller than others or have an effective cross-sectional profile that results in the projected pressurized air jet partially contacting the scrap piece, or even missing it entirely.

### BRIEF DESCRIPTION OF THE DRAWINGS

FIG. 1 illustrates a schematic of a material handling system configured in accordance with various embodiments of the present disclosure.

FIG. 2A illustrates an isometric view of a sorting nozzle assembly configured in accordance with embodiments of the present disclosure.

FIG. 2B illustrates an isometric view of the sorting nozzle assembly of FIG. 2A positioned in proximity to a conveyor system in accordance with embodiments of the present disclosure.

FIG. 2C illustrates a front view of the sorting nozzle assembly of FIG. 2A.

FIG. 3 illustrates a side view of the sorting nozzle assembly of FIG. 2A.

FIG. 4 illustrates an isometric view of the sorting nozzle assembly of FIG. 2A depicting a pattern overlay of pressurized air jets that would be projected by each of the nozzles in accordance with embodiments of the present disclosure.

FIG. 5 illustrates a front view of the sorting nozzle assembly of FIG. 2A depicting a pattern overlay of pressurized air jets that would be projected by each of the nozzles in accordance with embodiments of the present disclosure.

FIG. 6 illustrates a side view of the sorting nozzle assembly of FIG. 2A depicting a pattern overlay of pressurized air jets that would be projected by each of the nozzles in accordance with embodiments of the present disclosure.

FIG. 7 illustrates a top view of the sorting nozzle assembly of FIG. 2A depicting a distribution of pressurized air jets that would be projected by each of the pairs of nozzles in accordance with embodiments of the present disclosure.

FIG. 8 illustrates an isometric view of the sorting nozzle assembly of FIG. 2A depicting configuration planes representing configurations for positioning of the sorting nozzle assembly with respect to a conveyor system in accordance with embodiments of the present disclosure.

FIGS. 9A, 9B, 10A, 10B, 11A, 11B, 12A, 12B, 13A and 13B illustrate a non-limiting, exemplary firing sequence of the sorting nozzle assembly of FIG. 2A in accordance with certain embodiments of the present disclosure.

FIG. 14 illustrates a block diagram of an nozzle system configured in accordance with embodiments of the present disclosure.

FIGS. 15, 16 and 17 illustrate flowchart diagrams configured in accordance with various embodiments of the present disclosure.

FIG. 18 illustrates a cross-sectional side view of the sorting nozzle assembly of FIG. 2A depicting an internal air flow geometry of each pair of the nozzles in accordance with embodiments of the present disclosure.

FIG. 19 illustrates a cross-sectional side view of a prior art sorting nozzle assembly.

FIG. 20 illustrates an isometric view of a sorting nozzle assembly configured in accordance with alternative embodiments of the present disclosure.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be used in this application. The teachings can also be used in other applications, and with several different types of material or object sorting architectures.

Various detailed embodiments of the present disclosure are disclosed herein. However, it is to be understood that the disclosed embodiments are merely exemplary of the disclosure, which may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to employ various embodiments of the present disclosure.

In accordance with embodiments of the present disclosure, in response to the identification/classification of the individual material pieces as described with respect to a material handling system disclosed herein, a sorting nozzle assembly that includes an array of a plurality of nozzles may be configured to expel (e.g., project) in a controlled manner a gaseous or liquid media from orifices formed in tips of each of the nozzles towards/against material pieces transported past the sorting nozzle assembly.

Certain embodiments of the present disclosure provide for a sorting nozzle assembly with an array of nozzles that are oriented at projection angles relative to each other so that each nozzle's intended focal point or target location relative to the conveyor belt more effectively diverts material pieces having different sizes, shapes, and/or masses.

Certain embodiments of the present disclosure provide for a sorting nozzle assembly in which the gaseous media (e.g., pressurized (for example, compressed) air) provided to the multiple nozzles is activated in a sequence that follows the material pieces as they are transported on a conveyor belt past the sorting nozzle assembly. Such an arrangement optimizes the effective diverting force on each material piece, minimizes consumption of the gaseous media (e.g., pressurized air) supplied to the sorting nozzle assembly, and increases precision of the projected gaseous media from the nozzles so not to affect adjacent material pieces on the conveyor belt.

Certain embodiments of the present disclosure are configured to send control signals to a sorting nozzle assembly to cause one or more nozzles within the sorting nozzle assembly to actuate in order to effect a desired motion of a material piece relative to a substrate on which it has been deposited.

Certain embodiments of the present disclosure provide for a sorting nozzle assembly in which internal conduits may be designed for a more efficient flow of air, which increases the response time from when a pressurized air jet is actuated from a nozzle. Further, the internal conduits may be configured for producing a laminar flow of air within the conduits for a more precise stream of air versus a turbulent flow in which the air stream spreads rapidly, and a reduced pressure is required to overcome internal air flow losses.

Certain embodiments of the present disclosure provide for a sorting nozzle assembly that may be three-dimensionally (“3-D”) printed to allow for shaping the internal conduits in a manner that may not be possible if the sorting nozzle assembly was machined.

As used herein, “materials” may include any item or object, including but not limited to, metals (ferrous and/or nonferrous), metal alloys (including, but not limited to, aluminum alloys), heavies, Zorba, Zebra, Twitch, pieces of metal embedded in another different material, plastics/polymers (including, but not limited to, any of the plastics/polymers disclosed herein, known in the industry, or newly created in the future), rubber, foam, printed circuit boards (“PCBs”), glass (including, but not limited to, borosilicate or soda lime glass, and various colored glass), ceramics, paper, cardboard, Teflon, PE, bundled wires, insulation covered wires, rare earth elements, leaves, wood, plants, parts of plants, textiles, bio-waste, packaging, electronic waste, batteries and accumulators, scrap from end-of-life (“EOL”) products (e.g., vehicles, aircraft, and/or white goods, such as appliances), mining, construction, and demolition waste, crop wastes, forest residues, purpose-grown grasses, woody energy crops, microalgae, food waste, coffee pods or cartridges, hazardous chemical and biomedical wastes, construction debris, farm wastes, biogenic items, non-biogenic items, objects with a specific carbon content, any other objects that may be found within municipal solid waste, and any other objects, items, or materials disclosed herein, including further types or classes of any of the foregoing that can be distinguished from each other, including but not limited to, by one or more sensor systems, including but not limited to, any of the sensor technologies disclosed herein.

In a more general sense, a “material” may include any item or object composed of a chemical element, a compound or mixture of chemical elements, or a compound or mixture of a compound or mixture of chemical elements, wherein the complexity of a compound or mixture may range from being simple to complex (all of which may also be referred to herein as a material having a specific “chemical composition” (also referred to herein as a specific “material composition”)). “Chemical element” means a chemical element of the periodic table of chemical elements, including chemical elements that may be discovered after the filing date of this application. Within this disclosure, the terms “scrap,” “scrap pieces,” “materials,” “material pieces,” and “material scrap pieces” may be used interchangeably. As used herein, a material piece or scrap piece referred to as having a metal alloy composition is a metal alloy having a specific chemical composition that distinguishes it from other metal alloys. As used herein, a “contaminant” is any material, or a component of a material piece, that is to be excluded from a group of sorted materials.

As used herein, the term “predetermined” refers to something that has been established or decided in advance, such as by a designer or user of embodiments of the present disclosure.

As used herein, the term “chemical signature” refers to a unique pattern (e.g., fingerprint spectrum), as would be produced by one or more analytical instruments, indicating the presence of one or more specific elements or molecules (including polymers) in a sample. The elements or molecules may be organic and/or inorganic. Such analytical instruments include any of the sensor systems disclosed herein, and also disclosed in U.S. Pat. No. 11,969,764, which is hereby incorporated by reference herein. In accordance with embodiments of the present disclosure, one or more such sensor systems may be configured to produce a chemical signature of a material piece.

As used herein, the term “image data” refers to a packet of digital data pertaining to a captured visual image of an individual material piece.

As used herein, the term “sort,” and any derivatives thereof, refers to the physical separation of certain material pieces (e.g., specifically classified material pieces) from other material pieces, for example, by the diverting of certain (selected) material pieces from a conveyor belt.

As used herein, the terms “identify” and “classify,” the terms “identification” and “classification,” and any derivatives of the foregoing, may be utilized interchangeably. As used herein, to “classify” a material piece is to assign or determine (i.e., identify) a type or class of materials to which the material piece belongs. For example, in accordance with certain embodiments of the present disclosure, a vision system (as further described herein) and/or sensor system (as further described herein) may be configured to capture (collect) and analyze any type of information for classifying materials and distinguishing such classified materials from other materials, which classifications can be utilized within a sorting system to selectively sort material pieces as a function of a set of one or more physical and/or chemical characteristics (e.g., which may be user-defined), including but not limited to, color, texture, hue, shape, brightness, weight, density, chemical composition, size, uniformity, manufacturing type, chemical signature, predetermined fraction, radioactive signature, transmissivity to light, sound, or other signals, and reaction to stimuli such as various fields, including emitted and/or reflected electromagnetic radiation (“EM”) of the material pieces.

The types or classes (i.e., classifications) of material pieces may be user-definable (e.g., predetermined) and not limited to any known classification(s) of materials. The granularity of the types or classes may range from very coarse to very fine. For example, the types or classes may include plastics, ceramics, glasses, metals, foam, wood, and other materials, where the granularity of such types or classes is relatively coarse; different metals and metal alloys such as, for example, zinc, copper, brass, lead, chrome plate, nickel plate, stainless steel, and aluminum, where the granularity of such types or classes is finer; or between specific types of aluminum alloys, where the granularity of such types or classes is relatively fine. Thus, the types or classes may be configured to distinguish between materials of significantly different chemical compositions such as, for example, plastics and metal alloys, or to distinguish between materials of almost identical chemical compositions such as, for example, different types of aluminum alloys. It should be appreciated that the methods and systems discussed herein may be applied to accurately identify/classify material pieces for which the chemical composition is completely unknown before being classified.

As used herein, “manufacturing type” refers to the type of manufacturing process by which the material piece was manufactured, such as a metal part having been formed by a wrought process, having been cast (including, but not limited to, expendable mold casting, permanent mold casting, and powder metallurgy), having been extruded, having been forged, a material removal process, etc.

As referred to herein, a “conveyor system” may be any known piece of mechanical handling equipment that moves materials from one location to another, including, but not limited to, an aero-mechanical conveyor, automotive conveyor, conveyor belt, belt-driven live roller conveyor, bucket conveyor, chain conveyor, chain-driven live roller conveyor, drag conveyor, dust-proof conveyor, electric track vehicle system, flexible conveyor, gravity conveyor, gravity skatewheel conveyor, lineshaft roller conveyor, motorized-drive roller conveyor, overhead I-beam conveyor, overland conveyor, pharmaceutical conveyor, plastic belt conveyor, pneumatic conveyor, screw or auger conveyor, spiral conveyor, tubular gallery conveyor, vertical conveyor, vibrating conveyor, wire mesh conveyor, and conveying material pieces within a fluid past a vision system and/or a sensor system (including, but not limited to, very small particles suspended in the fluid).

The systems and methods described herein according to certain embodiments of the present disclosure receive a heterogeneous mixture of a plurality of material pieces (e.g., EOL scrap, Zorba, Heavies, Zebra, and/or Twitch), wherein at least one material piece within this heterogeneous mixture includes a chemical composition different from one or more other material pieces and/or at least one material piece within this heterogeneous mixture is physically distinguishable from other material pieces, and/or at least one material piece within this heterogeneous mixture is of a class or type of material different from the other material pieces within the mixture, and the systems and methods are configured to identify/classify/distinguish/sort this one material piece into a group separate from such other material pieces. Embodiments of the present disclosure may be utilized to sort any types or classes of materials as defined herein. By way of contrast, a homogeneous set or group of materials all fall within the same identifiable class or type of material.

Certain embodiments of the present disclosure will be described herein as classifying and sorting material pieces into such separate groups or collections by sorting out the material pieces (e.g., physically depositing (e.g., ejecting or diverting) the material pieces into separate receptacles or bins, or onto another conveyor system), as a function of user-defined or predetermined groupings or collections (e.g., material piece classifications). As an example, within certain embodiments of the present disclosure, material pieces are sorted into separate receptacles in order to separate material pieces composed of a particular material composition, or compositions, from other material pieces composed of a different material composition.

It should be noted that the materials to be sorted may have irregular or varying sizes, masses, and/or shapes. For example, such material (e.g., Zorba, Zebra, and/or Twitch) may have been previously run through some sort of shredding mechanism that chops up the materials into such irregularly shaped and sized pieces (producing scrap pieces), which may then be fed or diverted onto a conveyor system for sorting.

Certain embodiments of the present disclosure may be configured to sort aluminum alloy material pieces into separate receptacles so that substantially all of the aluminum alloy material pieces having a material composition falling within one of the aluminum alloy series published by the Aluminum Association are sorted into a single receptacle (for example, a receptacle may correspond to one or more particular aluminum alloy series (e.g., 1xxx, 2xxx, 3xxx, 4xxx, 5xxx, 6xxx, 7xxx, 8xxx, 1xx, 2xx, 3xx, 4xx, 5xx, 6xx, 7xx, 8xx, 9xx)). Furthermore, as will be described herein, certain embodiments of the present disclosure may be configured to sort metal alloys into separate receptacles as a function of a classification of their metal alloy composition even if such metal alloy compositions fall within the same alloy series (e.g., as defined by the Aluminum Association). As a result, the sorting system configured in accordance with certain embodiments of the present disclosure can classify and sort aluminum alloy material pieces having compositions that would all classify them into a single aluminum alloy series (e.g., the 3xx series or the 5xx series) into separate receptacles as a function of their aluminum alloy composition. For example, certain embodiments of the present disclosure can classify and sort into separate receptacles aluminum alloy material pieces classified as cast aluminum alloy 360 separate from aluminum alloy material pieces classified as cast aluminum alloy 380 (or other similar cast aluminum alloys, such as 383).

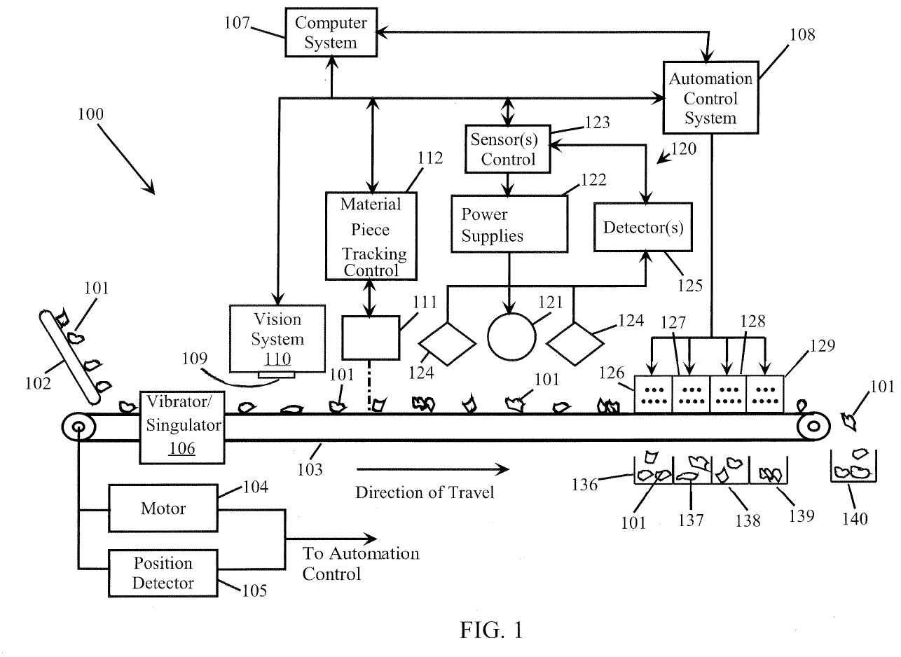

FIG. 1 illustrates a non-limiting example of a material handling system 100 configured in accordance with various embodiments of the present disclosure. A conveyor system 103 may be implemented to convey individual material pieces 101 through the material handling system 100 so that each of the individual material pieces 101 can be tracked, classified, distinguished, and/or sorted into predetermined desired groups (e.g., material classifications). Identification/classification of each of the material pieces 101 may be performed by one or more sensor systems, such as a vision system 110 and/or other types of sensor systems 120 as will be further described herein.

The conveyor system 103 may be implemented with one or more conveyor belts on which the material pieces 101 travel, typically at a predetermined constant speed. However, certain embodiments of the present disclosure may be implemented with other types of conveyor systems, including a system in which the material pieces free fall past one or more of the various components of the material handling system 100 (or any other type of vertical sorter), or any of the other conveyor systems disclosed herein. Hereinafter, wherein applicable, the conveyor system 103 may also be referred to as the conveyor belt 103. In one or more embodiments, some or all of the acts or functions of conveying, capturing, stimulating, detecting, classifying, distinguishing, and sorting may be performed automatically, i.e., without human intervention. For example, in the material handling system 100, one or more cameras, one or more vision systems, one or more sensor systems, one or more sources of stimuli, one or more emissions detectors, one or more classification modules, a sorting apparatus, one or more sorting devices, and/or other system components may be configured to perform these and other operations automatically.

Furthermore, though the simplified illustration in FIG. 1 depicts a single stream of material pieces 101 on a conveyor system 103, embodiments of the present disclosure may be implemented in which a plurality of such streams of material pieces are passing by the various components of the material handling system 100 in parallel with each other. In accordance with certain embodiments of the present disclosure, some sort of suitable feeder mechanism (e.g., another conveyor system, bowl feeder, or hopper 102) may be utilized to feed the material pieces 101 onto the conveyor system 103, whereby the conveyor system 103 conveys the material pieces 101 past various components within the material handling system 100. In accordance with certain embodiments of the present disclosure, a tumbler and/or a vibrator may be utilized to separate the individual material pieces from a collection (e.g., a physical pile) of material pieces. In accordance with certain embodiments of the present disclosure, the material pieces may be positioned into one or more singulated (i.e., single file) streams, which may be performed by an active or passive singulator 106. An example of a passive singulator is further described in U.S. Pat. No. 10,207,296.

As such, certain embodiments of the present disclosure are capable of simultaneously tracking, classifying, distinguishing, and/or sorting such travelling streams of material pieces. Alternatively, the conveyor system (e.g., the conveyor belt 103) may simply convey a collection of material pieces, which have been deposited onto the conveyor belt 103, in a random manner. As such, in accordance with certain embodiments of the present disclosure, singulation of the material pieces 101 is not required to track, classify, distinguish, and/or sort the material pieces.

Within certain embodiments of the present disclosure, the conveyor belt 103 is operated to travel at a predetermined speed by a conveyor system motor 104. This predetermined speed may be programmable and/or adjustable by the operator in any well-known manner. Within certain embodiments of the present disclosure, control of the conveyor system motor 104 and/or the position detector 105 may be performed by an automation control system 108. Such an automation control system 108 may be operated under the control of a computer system 107, and/or the functions for performing the automation control may be implemented in software within the computer system 107. If the conveyor system 103 is a conveyor belt, then it may be a conventional endless belt conveyor employing a conventional drive motor 104 suitable to move the conveyor belt 103 at the predetermined speeds.

A position detector 105 (e.g., a conventional encoder) may be operatively coupled to the conveyor belt 103 and the automation control system 108 to provide information corresponding to the movement (e.g., speed) of the conveyor belt 103. Thus, as will be further described herein, through the utilization of the controls to the conveyor belt drive motor 104 and/or the automation control system 108 (and alternatively including the position detector 105), as each of the material pieces 101 travelling on the conveyor belt 103 are identified, they can be tracked by location and time (relative to the various components of the material handling system 100) so that the various components of the material handling system 100 can be activated/deactivated (including, activation of subsets of nozzles within a sorting nozzle assembly as further described herein) as each material piece 101 passes within their vicinity. As a result, the automation control system 108 is able to track the location of each of the material pieces 101 while they travel along the conveyor belt 103.

The vision system 110 may be configured to perform certain types of identification (e.g., classification) of all or a portion of the material pieces 101 (also referred to herein as a “vision check”), as will be further described herein. For example, such a vision system 110 may be utilized to capture or acquire information about each of the material pieces 101. For example, the vision system 110 may be configured (e.g., with an artificial intelligence (“AI”) system as further described herein) to capture or collect any type of information from the material pieces that can be utilized within the material handling system 100 to classify the material pieces 101 as a function of a set of one or more characteristics (e.g., physical, chemical, and/or radioactive, etc.) as described herein. In accordance with certain embodiments of the present disclosure, the vision system 110 may be configured to capture visual images of each of the material pieces 101 (including one-dimensional, two-dimensional, three-dimensional, or holographic imaging), for example, by using an optical sensor as utilized in typical digital cameras and video equipment. Such visual images captured by the optical sensor are then stored in a memory device as image data (e.g., formatted as image data packets). In accordance with certain embodiments of the present disclosure, such image data may represent images captured within optical wavelengths of light (i.e., the wavelengths of light that are observable by the typical human eye). However, alternative embodiments of the present disclosure may utilize vision systems that are configured to capture an image of a material made up of wavelengths of light outside of the visual wavelengths of the human eye.

In accordance with alternative embodiments of the present disclosure, the vision system 110 may also be utilized as a means to track each of the material pieces 101 as they travel on the conveyor system 103, which may utilize one or more still or live action cameras 109 to note the position (i.e., location and timing) of each of the material pieces 101 on the moving conveyor system 103.

In accordance with alternative embodiments of the present disclosure, the vision system 110 may implement a machine vision system for analyzing and/or determining the shapes, or relative shapes, of each of the material pieces 101, such as might be implemented within LabVIEW.

In accordance with certain embodiments of the present disclosure, the material handling system 100 may be implemented with one or more sensor systems 120, which may be utilized solely or in combination with the vision system 110 to classify/identify/distinguish the material pieces 101 (for example, as described in U.S. Pat. Nos. 10,207,296, 10,710,119, 10,722,922, 11,260,426, 11,471,916, 11,964,304, 11,278,937, 12,030,088, 11,975,365, 12,017,255, 11,969,764, 12,103,045, 12,109,593, 12,194,506, 12,246,355, 12,290,842, and 12,404,114, and U.S. published patent application nos. 2021/0346916, 2024/0246117, and 2024/0228180, each of which is hereby incorporated by reference herein). A sensor system 120 may be configured with any type of sensor technology, including sensors utilizing irradiated or reflected electromagnetic radiation (e.g., utilizing infrared (“IR”), Fourier Transform IR (“FTIR”), Forward-looking Infrared (“FLIR”), Very Near Infrared (“VNIR”), Near Infrared (“NIR”), Short Wavelength Infrared (“SWIR”), Long Wavelength Infrared (“LWIR”), Medium Wavelength Infrared (“MWIR” or “MIR”), Ultraviolet (“UV”), X-Ray Transmission (“XRT”) Spectroscopy, X-Ray Fluorescence (“XRF”) Spectroscopy, Laser Induced Breakdown Spectroscopy (“LIBS”), Laser Spark Spectroscopy (“LSS”), Laser-Induced Optical Emission Spectroscopy (“LIOES”), Raman Spectroscopy, Coherent Anti-stokes Raman Spectroscopy, Gamma-ray Spectroscopy, Hyperspectral Spectroscopy (e.g., any range beyond visible wavelengths), Acoustic Spectroscopy, NMR Spectroscopy, Microwave Spectroscopy, Terahertz Spectroscopy, Differential Scanning Calorimetry (“DSC”), Thermogravimetric analysis (“TGA”), Optical and scanning electron microscopy (“SEM”), and Chromatography (e.g., LC-PDA, LC-MS, LC-LS, GC-MS, GC-FID, HS-GC), including one-dimensional, two-dimensional, or three-dimensional imaging with any of the foregoing), or by any other type of sensor technology, including but not limited to, chemical or radioactive, all of which are to be distinguished herein from the implementation of a vision system that analyzes visual images utilizing an AI technology (e.g., an AI model). Implementation of an exemplary XRF spectroscopy system (e.g., for use as a sensor system 120 herein) is further described in U.S. Pat. No. 10,207,296. XRF can also be used within alternative embodiments of the present disclosure to identify inorganic materials within a plastic piece (e.g., for inclusion within a chemical signature).

As used herein, the terms “sensor system” and “sensor technology” may refer to the implementation of any of the sensor systems disclosed herein for classifying/identifying/distinguishing (also referred to herein as a “sensor system classification”) material pieces as distinguished from the use of a vision system utilizing an AI technology for classifying/identifying/distinguishing material pieces.

The following sensor systems may also be used within certain embodiments of the present disclosure for determining the chemical signatures of plastic pieces and/or classifying plastic pieces for sorting. The previously disclosed various forms of infrared spectroscopy (e.g., IR, FTIR, FLIR, VNIR, NIR, SWIR, LWIR, MWIR, and/or MIR) may be utilized to obtain a chemical signature specific of each plastic piece that provides information about the base polymer of any plastic material, as well as other components present in the material (mineral fillers, copolymers, polymer blends, etc.). DSC is a thermal analysis technique that obtains the thermal transitions produced during the heating of the analyzed material specific for each material. TGA is another thermal analysis technique resulting in quantitative information about the composition of a plastic material regarding polymer percentages, other organic components, mineral fillers, carbon black, etc. Capillary and rotational rheometry can determine the rheological properties of polymeric materials by measuring their creep and deformation resistance. Optical microscopy and SEM can provide information about the structure of the materials analyzed regarding the number and thickness of layers in multilayer materials (e.g., multilayer polymer films), dispersion size of pigment or filler particles in the polymeric matrix, coating defects, interphase morphology between components, etc. Chromatography can quantify minor components of plastic materials, such as UV stabilizers, antioxidants, plasticizers, anti-slip agents, etc., as well as residual monomers, residual solvents from inks or adhesives, degradation substances, etc.

Though FIG. 1 is illustrated as including one or more sensor systems 120, implementation of such sensor system(s) is optional within certain embodiments of the present disclosure. Within certain embodiments of the present disclosure, a combination of one or more vision systems and one or more sensor systems may be used to classify the material pieces 101. Within certain embodiments of the present disclosure, any combination of one or more of the different sensor technologies disclosed herein may be used to classify the material pieces 101 without utilization of a vision system 110.

In accordance with certain embodiments of the present disclosure, one or more vision systems and/or one or more sensor systems may be configured to identify which of the material pieces 101 contain a contaminant (e.g., steel or iron pieces containing copper; plastic pieces containing a specific contaminant, additive, or undesirable physical feature (e.g., an attached container cap formed of a different type of plastic than the container)), and send a signal to separate (sort out) such material pieces (e.g., from those not containing the contaminant). In such a configuration, the identified material pieces 101 may be diverted/ejected (sorted out) utilizing one of the sorting nozzle assemblies as described hereinafter for physically sorting material pieces.

Within certain embodiments of the present disclosure, the material piece tracking device 111 (or a commercially available profilometer) and accompanying control system 112 may be utilized and configured to measure the sizes, masses, and/or shapes of each of the material pieces 101 as they pass within proximity of the material piece tracking device 111, along with the position (i.e., location and timing) of each of the material pieces 101 on the moving conveyor system 103. An exemplary operation of such a material piece tracking device 111 and control system 112 is further described in U.S. Pat. No. 10,207,296. Exemplary operations of a profilometer and similar devices are described in U.S. Pat. No. 12,404,114, which is hereby incorporated by reference herein.

Alternatively, as disclosed herein, the vision system 110 may be utilized to track the position (i.e., location and timing) of each of the material pieces 101 as they are transported by the conveyor system 103. As such, certain embodiments of the present disclosure may be implemented without a material piece tracking device (e.g., the material piece tracking device 111) to track the material pieces.

Within certain embodiments of the present disclosure that implement one or more sensor systems 120, the sensor system(s) 120 may be configured to identify the chemical composition, relative chemical compositions (including, but not limited to, measuring the amounts of specific elements within a material piece), and/or manufacturing types of each of the material pieces 101 as they pass within proximity of the sensor system(s) 120. The sensor system(s) 120 may include an energy emitting source 121, which may be powered by a power supply 122, for example, in order to stimulate a response from each of the material pieces 101. Within certain embodiments of the present disclosure, as each material piece 101 passes within proximity to the emitting source 121, the sensor system 120 may emit an appropriate sensing signal towards the material piece 101. One or more detectors 124 may be positioned and configured to sense/detect one or more characteristics from the material piece 101 in a form appropriate for the type of utilized sensor technology. The one or more detectors 124 and the associated detector electronics 125 capture these received sensed characteristics to perform signal processing thereon and produce digitized information representing the sensed characteristics (e.g., spectroscopy data, such as XRF spectrum data), which is then analyzed to classify each of the material pieces 101.

In accordance with embodiments of the present disclosure, a sorting apparatus is configured with one or more sorting devices for redirecting selected material pieces 101 towards a desired location, including, but not limited to, diverting the material pieces 101 from the conveyor belt system. For example, in a sorting system (e.g., the material handling system 100), classification of material pieces, which may be performed within the computer system 107, may then be utilized by the automation control system 108 to activate one of N (N>1) sorting devices 126 ... 129 of a sorting apparatus for sorting (e.g., diverting/ejecting) the material pieces 101 (e.g., into one or more N (N>1) sorting receptacles 136 ... 139, or onto one or more other conveyor belts (not shown)) according to the determined classifications. Four sorting devices 126 ... 129 and four sorting receptacles 136 ... 139 associated with the sorting devices are illustrated in FIG. 1 as merely a non-limiting example.

In accordance with embodiments of the present disclosure, each of the one or more sorting devices is composed of a sorting nozzle assembly assigned to one or more of the classifications. When a sorting nozzle assembly (e.g., the sorting nozzle assembly 201 described herein) receives a control signal (e.g., from the automation control system 108), nozzles in the sorting nozzle assembly emit (project or expel) a gaseous media (e.g., a stream of air (also referred to herein as an “air jet”)) that causes a material piece 101 to be diverted/ejected from the conveyor system 103 into a sorting receptacle (e.g., one of the receptacles 136 ... 139) (or onto another conveyor system) corresponding to that sorting nozzle assembly. The stream of air, or air jet, may be produced by any well-known technique, including, but not limited to, a controlled burst release of compressed (pressurized) air.

In addition to the N sorting receptacles 136 ... 139 into which material pieces 101 are diverted/ejected, the material handling system 100 may also include a receptacle 140 that receives material pieces 101 not diverted/ejected from the conveyor system 103 into any of the aforementioned N sorting receptacles 136 ... 139. For example, a material piece 101 may not be diverted/ejected from the conveyor system 103 into one of the N sorting receptacles 136 ... 139 when the classification of the material piece 101 is not determined (or simply because the sorting devices failed to adequately divert/eject a piece). Thus, the receptacle 140 may serve as a default receptacle into which unclassified or unsorted material pieces are dumped. Alternatively, the receptacle 140 may be used to receive one or more classifications of material pieces that have deliberately not been assigned to any of the N sorting receptacles 136 ... 139. These such material pieces may then be further sorted in accordance with other characteristics and/or by another sorting system.

Depending upon the variety of classifications of material pieces desired, multiple classifications may be mapped to a single sorting device and/or associated sorting receptacle. In other words, there need not be a one-to-one correlation between classifications and sorting devices and/or receptacles. For example, it may be desired by the user to sort certain classifications of materials into the same sorting receptacle. To accomplish this sort, when a material piece 101 is classified as falling into a predetermined grouping of classifications, the same sorting device may be activated to sort these into the same sorting receptacle (or onto another conveyor belt). Such combination sorting may be applied to produce any desired combination of sorted material pieces. The mapping of classifications may be programmed by the user (e.g., using any of the sorting algorithms as described herein operated by the computer system 107) to produce such desired combinations. Additionally, the classifications of material pieces are user-definable, and not limited to any particular known classifications of material pieces.

The systems and methods described herein may be applied to classify and sort individual material pieces having any of a variety of sizes, masses, and/or shapes. Even though the systems and methods described herein are described primarily in relation to sorting individual material pieces of a singulated stream one at a time, the systems and methods described herein are not limited thereto. Such systems and methods may be used to stimulate and/or detect emissions from a plurality of materials concurrently. For example, as opposed to a singulated stream of materials being conveyed along one or more conveyor belts in series, multiple singulated streams may be conveyed in parallel. Each stream may be on a same belt or on different belts arranged in parallel. Further, pieces may be randomly distributed on (e.g., across and along) one or more conveyor belts. Accordingly, the systems and methods described herein may be used to stimulate, and/or detect emissions from, a plurality of these material pieces at the same time. In other words, a plurality of material pieces may be treated as a single piece as opposed to each material piece being considered individually. Accordingly, the plurality of material pieces may be classified and sorted (e.g., diverted/ejected from the conveyor system) together.

As previously noted, certain embodiments of the present disclosure may implement one or more vision systems (e.g., vision system 110) configured (e.g., in combination with an AI system) to classify, distinguish, and/or segment material pieces. Such an AI system may implement any well-known AI system (e.g., Artificial Narrow Intelligence (“ANI”), Artificial General Intelligence (“AGI”), Artificial Super Intelligence (“ASI”)), a machine learning system including one that implements a neural network (e.g., artificial neural network, deep neural network, multilayer perceptron, convolutional neural network, recurrent neural network, autoencoders, transformer-based model (e.g., multimodal large language model (“LLM”) (multimodal LLM), vision language model (“VLM”) etc.), a machine learning system implementing supervised learning, unsupervised learning, semi-supervised learning, weak supervised learning, reinforcement learning (e.g., represented by a Markov decision process (“MDP”) and/or implemented using Markov chains), self-learning, feature learning, sparse dictionary learning, anomaly detection, robot learning, association rule learning, fuzzy logic, deep learning algorithms, deep structured learning hierarchical learning algorithms, decision tree learning (e.g., classification and regression tree (“CART”), ensemble methods (e.g., ensemble learning, Random Forests, Bagging and Pasting, Patches and Subspaces, Boosting, Stacking, etc.), dimensionality reduction (e.g., Projection, Manifold Learning, Principal Components Analysis, etc.), and/or deep machine learning algorithms, such as those described in and publicly available at the fast. ai website (including all software, publications, and hyperlinks to available software referenced within this website), which is hereby incorporated by reference herein. Non-limiting examples of publicly available machine learning software and libraries that could be utilized within embodiments of the present disclosure include Python, OpenCV, Inception, Theano, Torch, PyTorch, Pylearn2, Numpy, Blocks, TensorFlow, MXNet, Caffe, Lasagne, Keras, Qt, Ubuntu, NVIDIA drivers, Pandas, Matplotlib, github, Chainer, Matlab Deep Learning, CNTK, MatConvNet (a MATLAB toolbox implementing convolutional neural networks for computer vision applications), DeepLearnToolbox (a Matlab toolbox for Deep Learning (from Rasmus Berg Palm)), BigDL, Cuda-Convnet (a fast C++/CUDA implementation of convolutional (or more generally, feed-forward) neural networks), Deep Belief Networks, RNNLM, RNNLIB-RNNLIB, matrbm, deeplearning4j, Eblearn. Ish, deepmat, MShadow, Matplotlib, SciPy, CXXNET, Nengo-Nengo, Eblearn, cudamat, Gnumpy, 3-way factored RBM and mcRBM, mPoT (Python code using CUDAMat and Gnumpy to train models of natural images), ConvNet, Elektronn, OpenNN, NeuralDesigner, Theano Generalized Hebbian Learning, Apache Singa, Lightnet, SimpleDNN, ResNet, Contrastive Language-Image Pre-training (“CLIP”), GPT-4 Vision, Large Language and Vision Assistant (“LLaVA”), ALIGN, BLIP, and VL-BERT.

Therefore, as disclosed herein, certain embodiments of the present disclosure provide for the identification/classification of one or more different materials so as to determine which material pieces should be diverted from a conveyor system. In accordance with certain embodiments, machine learning techniques may be utilized to train (i.e., configure) a neural network to identify a variety of one or more different classes or types of materials. Images, or other types of sensed information, may be captured of materials (e.g., traveling on a conveyor system), and based on the identification/classification of such materials, the systems described herein can decide which material piece should be allowed to remain on the conveyor system, and which should be diverted/removed from the conveyor system (for example, either into a collection receptacle, or diverted onto another conveyor system).

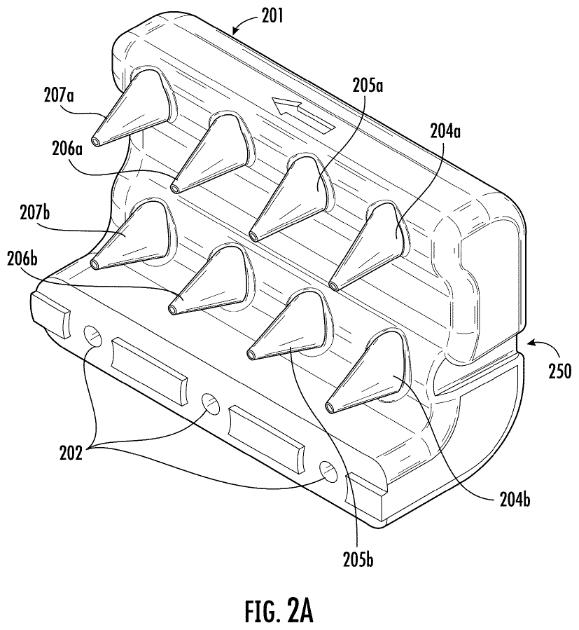

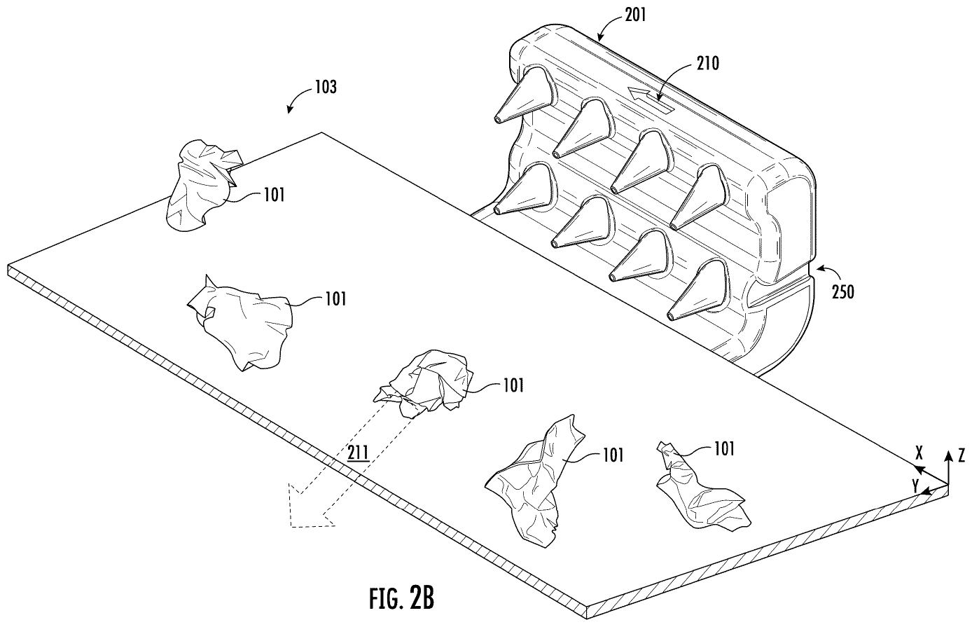

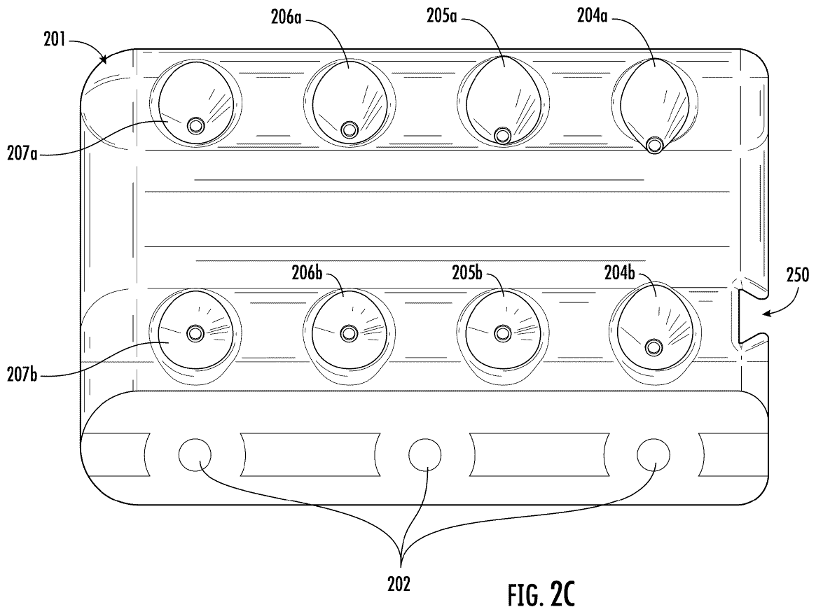

FIGS. 2A-13B illustrate embodiments of a sorting nozzle assembly 201 configured in accordance with embodiments of the present disclosure. The function and advantage of these and other embodiments of the present disclosure will be more fully understood from the examples discussed below. The following examples are intended to facilitate an understanding of the present disclosure and illustrate benefits of the present disclosure, but do not exemplify the full scope of the disclosure. For purposes of describing exemplary embodiments of the present disclosure, aspects and operation of the sorting nozzle assembly 201 will be described with reference to implementation within the material handling system 100. As such, the sorting nozzle assembly 201 may be utilized within any one or more of the sorting devices 126 ... 129 to sort material pieces 101 that are assigned a specific classification by which one or more nozzles within the sorting nozzle assembly 201 are then activated to “fire on” and eject such material pieces 101 from the conveyor belt 103. As described with respect to FIG. 1, sensed data associated with each of a plurality of material pieces 101 deposited on a conveyor belt 103 is captured for identifying/classifying each of the material pieces 101 to determine which of the material pieces 101 are to be sorted (separated) from other material pieces 101. The sorting nozzle assembly 201 may also be configured for implementation within any other embodiments of a sorting system that are designed to sort out material pieces from a flow of materials, such as on a conveyor belt or other type of conveyor system (for example, as described in U.S. Pat. Nos. 10,207,296, 10,710,119, 10,722,922, 11,260,426, 11,471,916, 11,964,304, 11,278,937, 12,030,088,11,975,365, 12,017,255, 11,969,764, 12,103,045, 12,109,593, 12,194,506, 12,246,355,12,290,842, 12,403,505, and 12,404,114, and U.S. published patent application nos. 2021/0346916 and 2024/0228180, each of which is hereby incorporated by reference herein).

FIG. 2A illustrates an isometric view of the sorting nozzle assembly 201. The sorting nozzle assembly 201 may be designed with a plurality of N (where N>1) nozzles, which may be configured in an array, for selectively (controllably) receiving a gaseous media in order to project the gaseous media from orifices to thereby divert a material piece 101 from a surface of an adjacent conveyor belt 103 as the material piece 101 is transported on the conveyor belt 103 past the sorting nozzle assembly 201. The sorting nozzle assembly 201 may be manufactured using any known technique, including the machining of a plastic, fiberglass, metal, etc. material. In accordance with embodiments of the present disclosure, a sorting nozzle assembly 201 may be formed using a 3D printing technique as is well known in the art. Alternatively, though the sorting nozzle assembly 201 is illustrated as an integrated unit, the sorting nozzle assembly 201 may be configured as separate individual nozzles. For the purposes of further description of such a sorting nozzle assembly, it will be assumed that the gaseous or liquid media is air (e.g., pressurized (for example, compressed) air from a pressurized air supply), though any appropriate gaseous or liquid media may be employed.

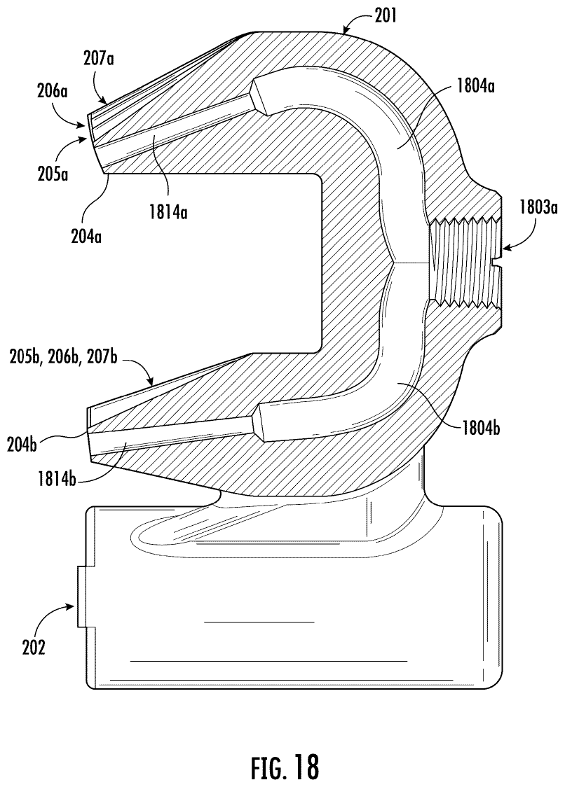

In accordance with a non-limiting example of the present disclosure, the sorting nozzle assembly 201 may be configured with an array of four pairs of nozzles 204a and 204b, 205a and 205b, 206a and 206b, and 207a and 207b (also referred to herein as nozzles 204a ... 207b). Though the sorting nozzle assembly 201 is described herein with an array of nozzles 204a ... 207b, the sorting nozzle assembly 201 may be configured with any number of N (where N>1) nozzles. In accordance with non-limiting exemplary embodiments of the present disclosure, the sorting nozzle assembly 201 may be configured with an array of two rows of nozzles (an upper row and a lower row), but any appropriate number of rows of nozzles may be implemented. In accordance with non-limiting exemplary embodiments of the present disclosure, the array is configured in pairs of nozzles, with one of the nozzles in each pair being positioned above the other, wherein both nozzles in a pair may be activated at the same time. As will be further disclosed herein with respect to FIG. 18, the internal conduits for each pair of nozzles may be connected so that such pairs of nozzles receive pressurized air simultaneously.

As will be further described herein, at least a subset n (where n≤N) of the array of nozzles 204a ... 207b may be controllably selected based at least in part on an attribute of a material piece 101 (e.g., its physical configuration, such as size, mass, or shape) to be sorted from a conveyor belt 103. As described herein, a control signal may be generated within the material handling system 100 to cause the sorting nozzle assembly 201 to use the selected subset n of the nozzles 204a ... 207b to perform a sorting action on a classified material piece 101. The control signal may be configured to use a selected number or all of the nozzles 204a ... 207b to divert a material piece 101 from the conveyor belt 103 as a function of a determination of the size, mass, and/or shape of the material piece 101. For example, a greater number n of the nozzles 204a ... 207b within the sorting nozzle assembly 201 may be selected and/or configured to project pressurized air jets for a longer duration for a material piece 101 that has been determined to have a larger size and/or mass (e.g., a size and/or mass greater than a predetermined threshold amount). For example, image data captured from a material piece 101 by the vision system 110, or information captured by the material piece tracking control system 112, may determine the sizes, masses, and/or shapes of each of the material pieces 101. In accordance with alternative embodiments of the present disclosure, additional factors that may be utilized to control the firing of each of the nozzles 204a ... 207b within the sorting nozzle assembly 201 may include the determined speed of the conveyor belt 103, the orientation of a material piece 101 deposited on the conveyor belt 103, the classification of a material piece 101, or the relative distance of a material piece 101 from the sorting nozzle assembly 201 (or a position of a material piece 101 relative to a longitudinal midplane of the conveyor belt) as it passes by on the conveyor belt 103.

In response to receiving such a control signal from the automation control system 108, the sorting nozzle assembly 201 may be configured to activate the selected subset of the nozzles 204a ... 207b that are instructed by the control signal to perform a sorting action on a classified material piece 101 by activation of released pressurized air jets out of the orifices of the selected subset of the nozzles 204a ... 207b so that such projected air jets are directed at and contact the material piece 101 to divert it from a surface of the conveyor belt 103.

FIG. 2B depicts how the sorting nozzle assembly 201 may be exemplary positioned adjacent (in proximity) to a conveyor belt surface (e.g., the proximal side of the conveyor belt 103) on which material pieces 101 have been deposited and are conveyed (transported in the X direction) past the sorting nozzle assembly 201, such as described with respect to FIG. 1. For example, the sorting nozzle assembly 201 may be mounted to a frame (not shown) in proximity to the proximal side of a conveyor belt utilizing one or more screw or bolt fasteners inserted through one or more holes 202 formed within the body of the sorting nozzle assembly 201. However, the manner by which a sorting nozzle assembly 201 is mounted within a sorting system (e.g., the material handling system 100) can be accomplished using any known technique. The arrow 210 (which may optionally be imprinted or formed on a surface of the sorting nozzle assembly 201) is merely provided to indicate the direction of the conveyance of the material pieces 101 on the conveyor belt 103 past the sorting nozzle assembly 201. The arrow 210 may also be utilized by the user when installing the sorting nozzle assembly 201 within a sorting system. Embodiments of the present disclosure will be described hereinafter with respect to such a directional conveyance of material pieces past the sorting nozzle assembly 201. However, a sorting nozzle assembly 201 may be configured so that it is designed to divert material pieces 101 from the conveyor belt 103 flowing in an opposite direction. Moreover, the arrow 210 formed within the body of the sorting nozzle assembly 201 is not necessary for operation of the sorting nozzle assembly 201. The dashed arrow 211 is included within FIG. 2B to demonstrate the general direction that a selected material piece 101 will be diverted from the distal side of the conveyor belt 103 by operation of the sorting nozzle assembly 201 (for example, in a receptacle (e.g., the receptacle 136) or onto another conveyor system).

The X, Y, Z coordinates depicted in FIGS. 2B, 8, 13A, and 13B are utilized for explaining relative positioning of various aspects of embodiments. For purposes of this disclosure, the X coordinate represents the longitudinal dimension of the conveyor belt surface; the Y coordinate represents the transverse dimension of the conveyor belt surface; and the Z coordinate represents height dimensions above the conveyor belt surface.

In accordance with embodiments of the present disclosure, the sorting nozzle assembly 201 may be positioned adjacent to a proximal side of the conveyor belt 103 and relative to the top surface of the conveyor belt 103 so that the lower row of nozzles 204b, 205b, 206b, and 207b are positioned a predetermined and desired height (Z) above the plane of the top surface of the conveyor belt 103. Such a predetermined height (Z) may be designed by the user for effective diversion of certain (e.g., known) material pieces 101 (e.g., of certain sizes). As will be further described herein, the relative heights and orientations (angles relative to the conveyor belt surface) of the nozzles within the array may be positioned for an effective diversion of material pieces positioned (deposited on) substantially within a centerline of the conveyor belt 103 (or any other predetermined transverse position (Y) along a width of the conveyor belt).

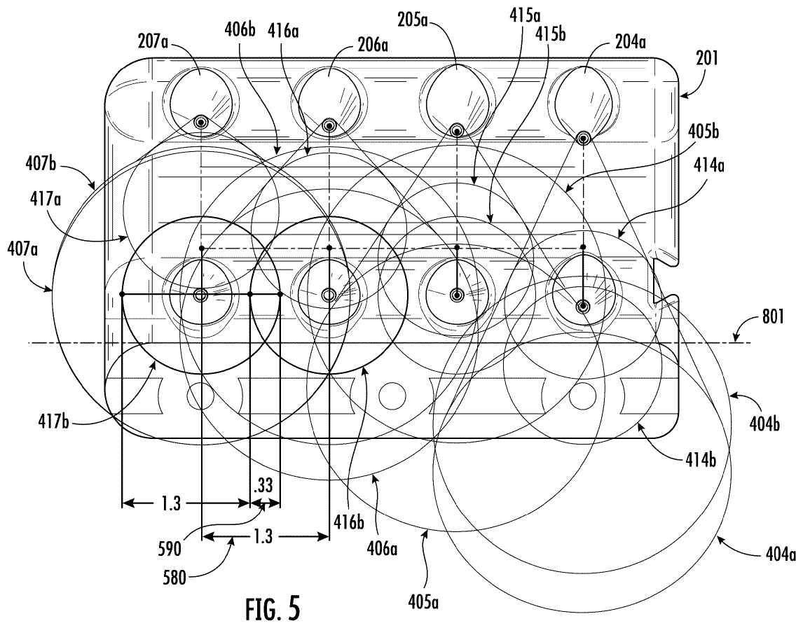

FIG. 2C illustrates a front view of the sorting nozzle assembly 201. In accordance with non-limiting exemplary embodiments of the present disclosure, the various nozzles of the sorting nozzle assembly 201 may be arranged in one or more rows in a side-by-side manner (and at a pitch), and may be oriented at different angles relative to each other, so as to form an aggregated array of nozzles for effecting a diversion of a material piece 101 from a conveyor belt 103 in a desired manner. The pitch is defined herein as the distance between the centerlines of two neighboring nozzles (for example, see the pitch 580 in FIG. 5 with a non-limiting exemplary dimension given as 1.3).

FIG. 2C also shows how various nozzles within an array (e.g., the nozzles 204a, 205a, 206a, and 207a) may be configured/oriented to project pressurized air jets in different directions (vectors) relative to each other, and with respect to a horizontal plane parallel to a surface of the conveyor belt 103 (e.g., at different angles relative to the conveyor belt surface). Embodiments of the present disclosure are not limited to the specific nozzle orientations shown in FIG. 2C.

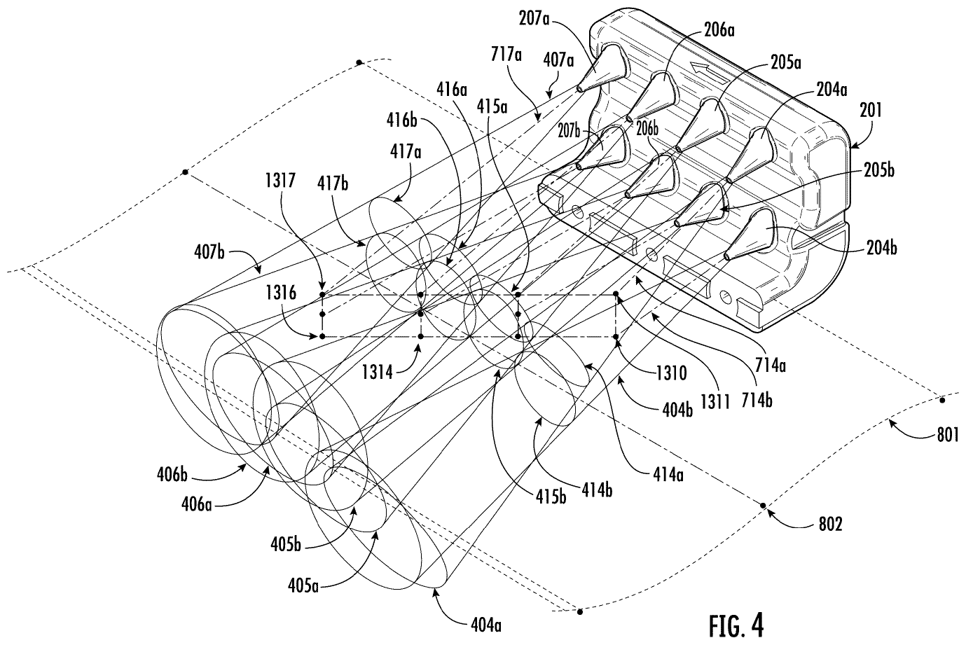

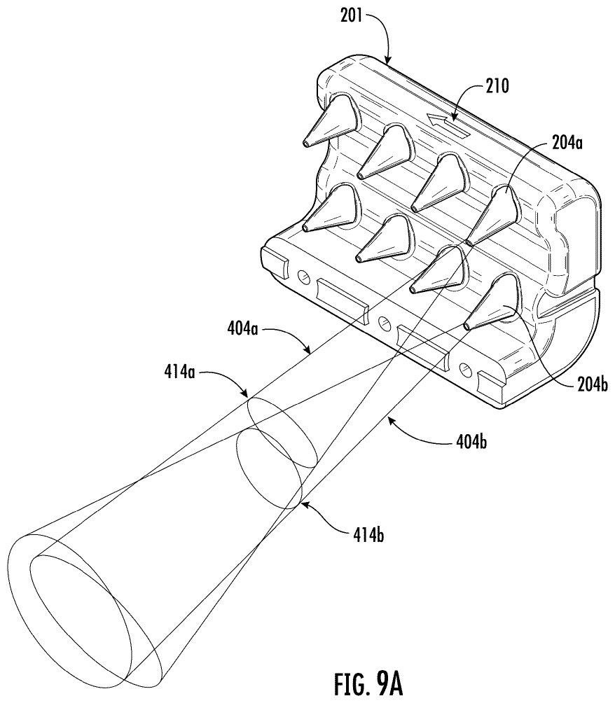

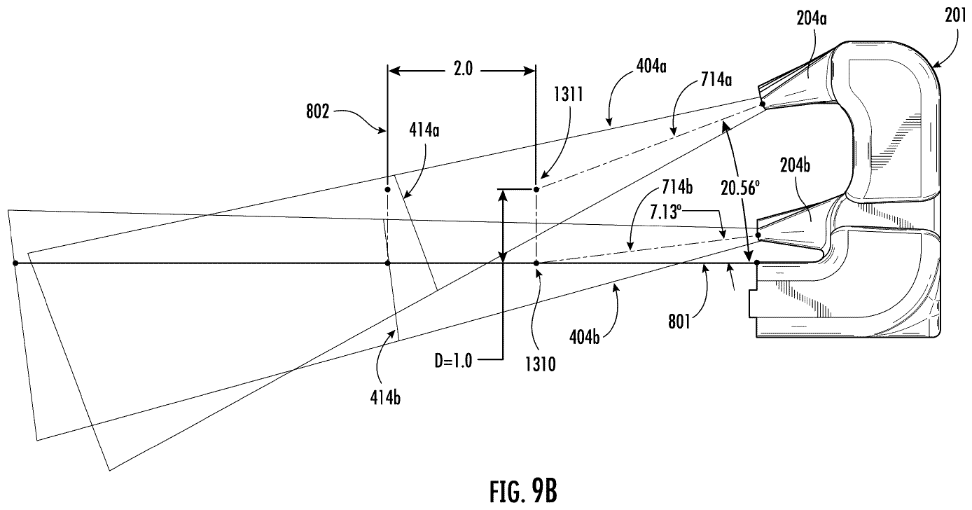

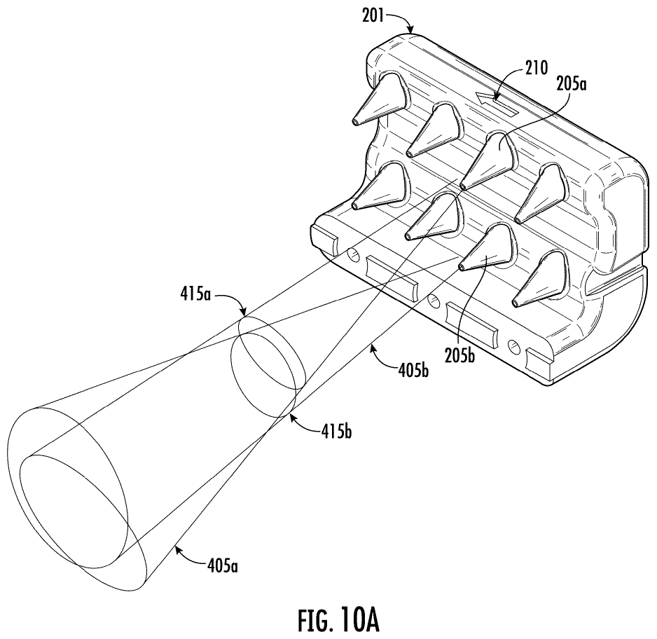

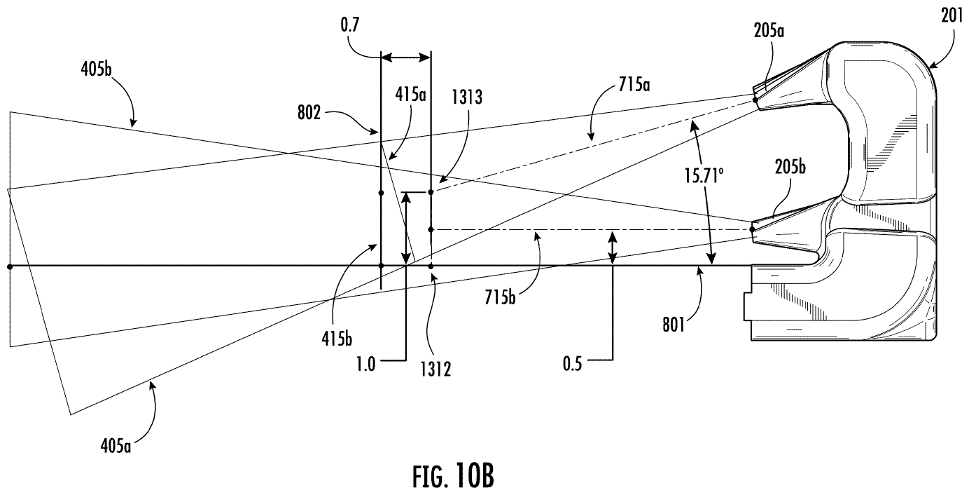

In accordance with certain embodiments of the present disclosure, one or more of the N nozzles in an array of nozzles may be configured to project its air jet along a vector aligned at a lower angle than one or more adjacent nozzles. For example, in accordance with non-limiting exemplary embodiments of the present disclosure, any one or more of the nozzles 205b, 206b, and 207b may be aligned to project their respective air jets along parallel vectors (e.g., in a substantially horizontal direction transversely across (parallel to) the surface of the conveyor belt 103 (for example, see FIGS. 10B, 11B, and 12B)), while the nozzle 204b may be configured to project its air jet along a vector (in a direction) of a predetermined lower angle than that of the nozzles 205b, 206b, 207b (e.g., so that its respective air jet is directed in a downward vector (angle) towards the surface of the conveyor belt 103 relative to the air jets emanating from the nozzles 205b, 206b, and 207b (for example, see FIG. 9B)). For example, the nozzle 204b may be configured so that its projected air jet is directed along a vector at a target location (position) on the surface of the conveyor belt 103 in order to more effectively eject or divert (blow off) small and/or flat material pieces (e.g., a material piece deposited on the surface of the conveyor belt 103 so that its cross-sectional profile is in very close proximity to the surface of the conveyor belt 103) off of the conveyor belt 103 as well as to lift such material pieces upwards (from the conveyor belt surface) into the paths of projected air jets of one or more other nozzles (e.g., one or more of the nozzles 204a and/or 205a ... 207b so that those nozzle(s) can then more effectively displace the material pieces transversely across the conveyor belt 103 towards the distal side and eject the material pieces from the conveyor belt 103. For example, as will be further explained with respect to FIGS. 4 and 9B, the nozzle 204b may be configured so that a vector 714b of its projected air jet is substantially aimed at a specified target location 1310 on the surface of the conveyor belt 103.

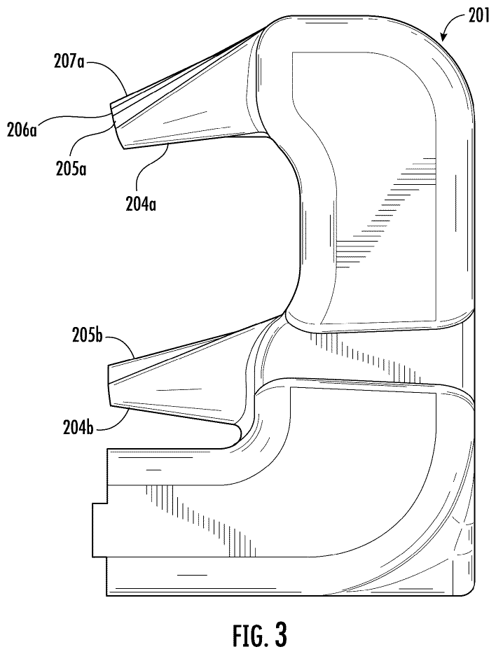

FIG. 3 illustrates a side view of the sorting nozzle assembly 201 configured in accordance with embodiments of the present disclosure. This side view is of the right side of the sorting nozzle assembly 201 showing the relative orientations (angles) of some of the nozzles as previously described.

As will be further described with respect to FIGS. 4-12B, the nozzles 204a, 205a, 206a, and 207a may be configured/oriented at various predetermined angles so that their respective air jets emanate at different vectors (directions downward) towards predetermined target locations relative to the surface of the conveyor belt 103.

While at least some of the nozzles 204a ... 207b are angled downwards toward the conveyor belt 103, in alternative embodiments, at least some of the nozzles 204a ... 207b may be configured to be angled (oriented) in any other direction relative to an adjacent conveyor system. In alternative embodiments, one or more of the nozzles 204a ... 207b of the array may be configured to be mechanically actuated to rotate around an axis in order to deflect target objects (e.g., material pieces) into different directions.

In accordance with alternative embodiments of the present disclosure, the sorting nozzle assembly 201 may be configured to include some sort of appropriate dovetail notch 250 so that multiple sorting nozzle assemblies can be coupled together, or so that some other unit can be coupled to the sorting nozzle assembly 201, such as a timing calibration sensor (not shown) that can be used with a calibration procedure to set more accurate and repeatable timing for a material piece blowoff sequence, such as described with respect to FIGS. 9A-12B.

FIGS. 4-6 illustrate how each of the nozzles 204a ... 207b within the sorting nozzle assembly 201 may be configured for concentrated, targeted delivery or projection of their respective air jets in various vectors (directions) relative to each other. In accordance with embodiments of the present disclosure, each of the nozzles 204a ... 207b may be configured to project an air jet that emanates from an orifice formed in the tip of the nozzle to spread in a conical manner. Air expands when it is discharged from a nozzle orifice, which leads to expansion of the air jet. This is represented by each of the depicted cones. Though embodiments of the sorting nozzle assembly 201 are described with conical orifices, other shaped orifice designs may be utilized, which may be configured to project air jets having projection patterns of other shapes.

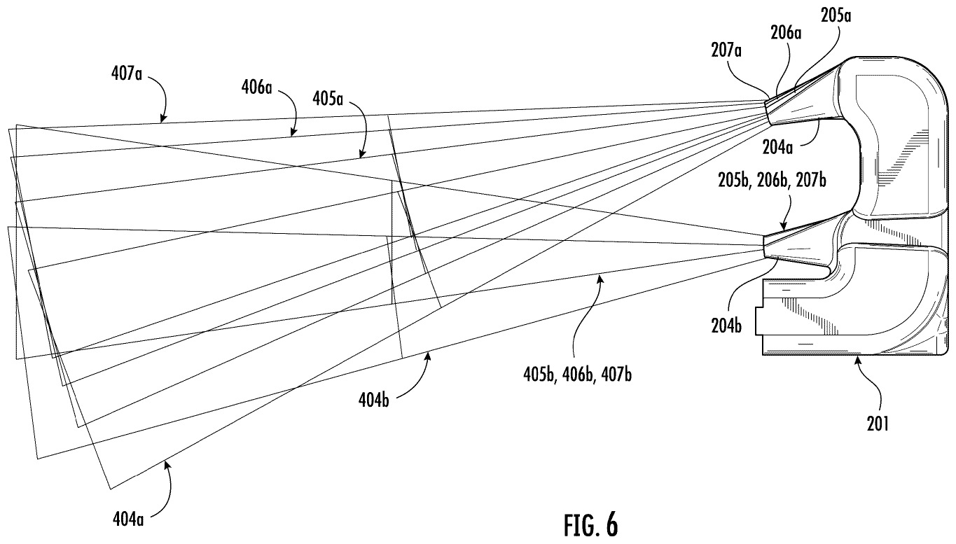

FIG. 4 illustrates an isometric view of the sorting nozzle assembly 201 depicting a non-limiting exemplary pattern overlay of air jets that could be projected by each of the nozzles 204a ... 207b in accordance with various embodiments of the present disclosure. FIG. 5 illustrates a front view of the sorting nozzle assembly 201 depicting the pattern overlay of the air jets that could be projected by each of the nozzles 204a ... 207b. FIG. 6 illustrates a side view of the sorting nozzle assembly 201 depicting the pattern overlay of the air jets that could be projected by each of the nozzles 204a ... 207b.

The nozzle 204a is configured to project an air jet represented by the air jet cone 404a; the nozzle 204b is configured to project an air jet represented by the air jet cone 404b; the nozzle 205a is configured to project an air jet represented by the air jet cone 405a; the nozzle 205b is configured to project an air jet represented by the air jet cone 405b; the nozzle 206a is configured to project an air jet represented by the air jet cone 406a; the nozzle 206b is configured to project an air jet represented by the air jet cone 406b; the nozzle 207a is configured to project an air jet represented by the air jet cone 407a; and the nozzle 207b is configured to project an air jet represented by the air jet cone 407b. The depicted air jet cones (and their respective centerlines) represent predetermined vectors and expanding shapes of the air jets to be projected from each of the nozzles.

As shown in FIG. 6, in accordance with embodiments of the present disclosure, the orientations of the various nozzles 204a ... 207b may be configured to discharge their respective air jets at predetermined specific angles to more efficiently eject or divert material pieces 101 from the conveyor belt 103 in a manner as described herein. Notably, the nozzle 204b can be seen to be positioned to project its air jet 404b along a vector at a predetermined angle (relative to the conveyor belt surface) while the nozzles 205b, 206b, and 207b may be configured to project their respective air jets 405b, 406b, and 407b along vectors that are substantially horizontal (i.e., parallel to the surface of the conveyor belt 103). The nozzle 204a may be configured to project its respective air jet 404a along a vector at a predetermined greater angle than the air jet 405a of the nozzle 205a; the nozzle 205a may be configured to project its respective air jet 405a along a vector at a predetermined greater angle than the air jet 406a of the nozzle 206a; and the nozzle 206a may be configured to project its respective air jet 406a along a vector at a predetermined greater angle than the air jet 407a of the nozzle 207a. This can also be readily seen in FIGS. 4 and 5.

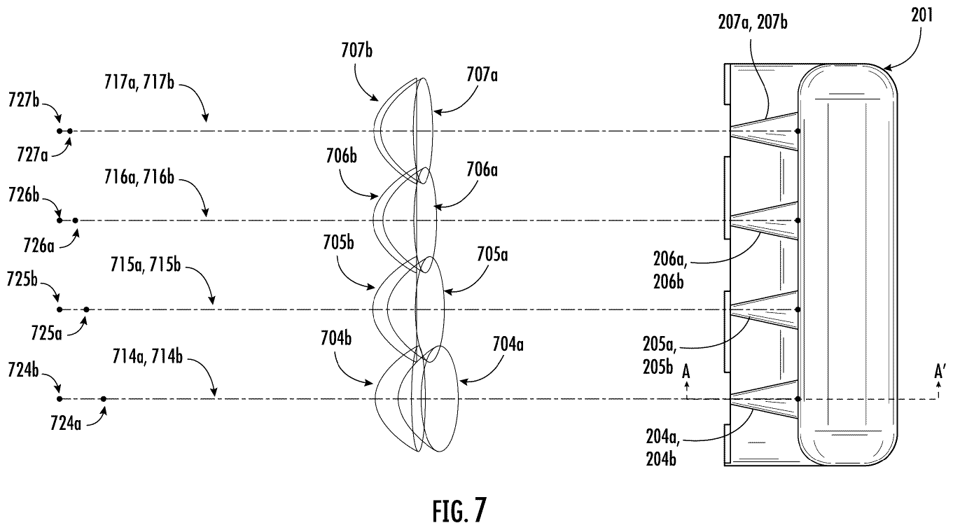

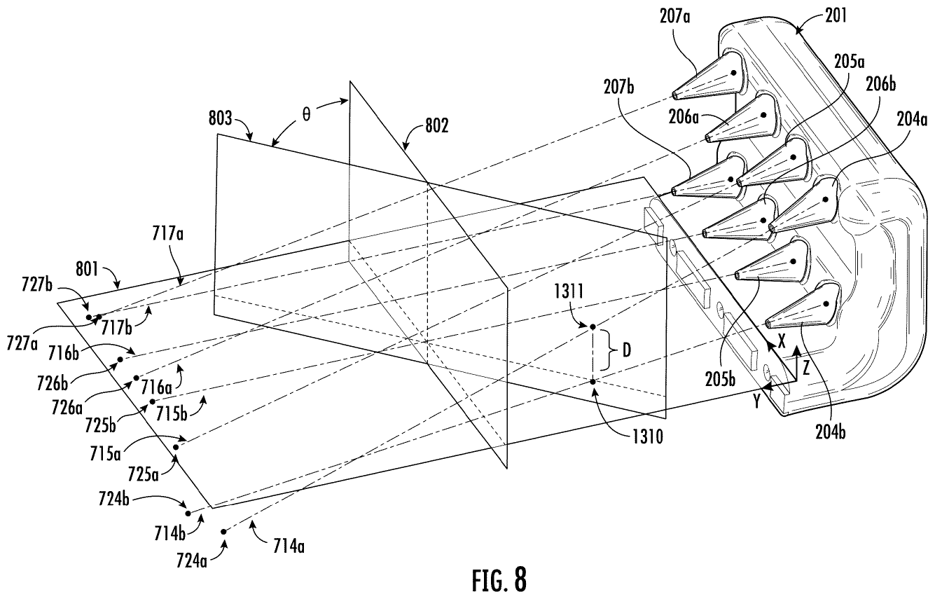

In FIG. 4, a surface of a conveyor belt (e.g., the conveyor belt 103) is represented as plane 801 with its midplane (i.e., halfway point in the transverse (Y) direction) represented as dashed line 802, both of which are further described with respect to FIG. 8. As further described with respect to FIG. 7, the lengths of each of the depicted air jet cones 404a ... 407b represent a predetermined pressure delivered by each of their respective nozzles 204a ... 207b.

Labels 414a and 414b represent the midpoints of the air jet cones 404a and 404b, respectively; labels 415a and 415b represent the approximate midpoints of the air jet cones 405a and 405b, respectively; labels 416a and 416b represent the approximate midpoints of the air jet cones 406a and 406b, respectively; and labels 417a and 417b represent the approximate midpoints of the air jet cones 407a and 407b, respectively. These midpoints (and their positions relative to the midplane 802) may be predetermined based on expected sizes, shapes, and/or masses of typical material pieces and typical variations of placements of material pieces on the conveyor belt.

In accordance with embodiments of the present disclosure, the air jet cones 404a and 404b may be directed along their respective vectors at their respective angles so that they more effectively initiate the displacement of a material piece 101 from the conveyor belt 103, including being more effective at commencing movement of any material pieces 101 that may have a flatter or lower profile. For example, the nozzles 204a and 204b may be configured so that their respective air jets 404a and 404b apply a sufficient force towards a selected material piece 101 on the conveyor belt 103 to overcome the static friction between the conveyor belt 103 and the material piece 101 in order to begin the displacement of the selected material piece 101 from a surface of the conveyor belt 103. For example, one or both of the nozzles 204a and 204b may be angled relative to the horizontal plane 801 of the conveyor belt so that the focal point(s) of the air jet(s) 404a, 404b is projected underneath the selected material piece 101. Correspondingly, one or more of the other various nozzles may be configured so that the vectors of their respective air jets are angled (e.g., in a more horizontal manner parallel to the conveyor belt surface) to complete the displacement/ejection of the material piece 101 from the conveyor belt 103, since such a material piece 101 will have been lifted up from the surface of the conveyor belt (by the air jet(s) 404a, 404b) and will already be beginning to tumble off of the surface (towards the distal side) of the conveyor belt 103 at a height above the surface of the conveyor belt 103 (i.e., to continue to force the material piece 101 off of the conveyor belt 103 so as to overcome dynamic friction because the material piece 101 has been placed in motion by the air jet(s) 404a, 404b).

In accordance with embodiments of the present disclosure, at a predetermined transverse location along the conveyor belt (e.g., the midplane 802 of the conveyor belt), it may be desirable to have a predetermined overlap (e.g., 25%) between the projected air jet spray patterns of adjacent air jet cones, so as to maintain the diverted material piece in motion once it has broken free from static friction and proceeded into dynamic friction. Such an overlap may also be different between different adjacent sets of air jet cones. For example, FIG. 5 depicts a non-limiting exemplary ˜25% overlap 590 between the centerline 716b of the air jet cone 406b at the midpoint 416b and the centerline 717b of the air jet cone 407b at the midpoint 417b, and so on. As previously disclosed with respect to FIG. 2C, label 580 represents a distance, or pitch, between a center of the air jet cone midpoint 416b (see centerline (vector) 716b in FIG. 6) and a center of the air jet cone midpoint 417b (see centerline (vector) 717b in FIG. 6). The distances 1.3 and 0.33 provided in FIG. 5C are merely exemplary for representing relative dimensions.

Referring next to FIG. 7, there is illustrated a top view of the sorting nozzle assembly 201 depicting representative relative pressure profiles for each of the pairs of nozzles. In the illustration of FIG. 7, the nozzle 204b is hidden underneath the view of the nozzle 204a; the nozzle 205b is hidden underneath the view of the nozzle 205a; the nozzle 206b is hidden underneath the view of the nozzle 2046; and the nozzle 207b is hidden underneath the view of the nozzle 207a.

The depicted overlapping lines 714a, 714b represent the vectors (centerlines) of the air jet cones 404a, 404b (see FIGS. 4-5) discharged from the nozzle pairs 204a, 204b, respectively; the depicted overlapping lines 715a, 715b represent the vectors (centerlines) of the air jet cones 405a, 405b discharged from the nozzle pairs 205a, 205b, respectively; the depicted overlapping lines 716a, 716b represent the vectors (centerlines) of the air jet cones 406a, 406b discharged from the nozzle pairs 206a, 206b, respectively; and the depicted overlapping lines 717a, 717b represent the vectors (centerlines) of the air jet cones 407a, 407b discharged from the nozzle pairs 207a, 207b, respectively.

The terminal end 724a of the vector 714a represents an exemplary first predetermined specific amount of air pressure discharged within the air jet cone 404a measured or calculated at a certain distance from the nozzle 204a along the vector 714a, while the terminal end 724b of the vector 714b represents that same exemplary first predetermined specific amount of air pressure discharged within the air jet cone 404b measured or calculated at a certain distance from the nozzle 204b along the vector 714b. The terminal end 725a of the centerline 715a represents an exemplary second predetermined specific amount of air pressure discharged within the air jet cone 405a measured or calculated at a certain distance from the nozzle 205a along the vector 715a, while the terminal end 725b of the vector 715b represents that same exemplary second predetermined specific amount of air pressure discharged within the air jet cone 405b measured or calculated at a certain distance from the nozzle 205b along the vector 715b. The terminal end 726a of the vector 716a represents an exemplary third predetermined specific amount of air pressure discharged within the air jet cone 406a measured or calculated at a certain distance from the nozzle 206a along the vector 716a, while the terminal end 726b of the vector 716b represents that same exemplary third predetermined specific amount of air pressure discharged within the air jet cone 406b measured or calculated at a certain distance from the nozzle 206b along the vector 716b. The terminal end 727a of the vector 717a represents an exemplary fourth predetermined specific amount of air pressure discharged within the air jet cone 407a measured or calculated at a certain distance from the nozzle 207a along the vector 717a, while the terminal end 727b of the vector 717b represents that same exemplary fourth predetermined specific amount of air pressure discharged within the air jet cone 407b measured or calculated at a certain distance from the nozzle 207b along the vector 717b. In accordance with embodiments of the present disclosure, two or more of the first, second, third, and fourth predetermined specific amounts of air pressure may be substantially the same. The midpoints 414a ... 417b represent halfway points between their respective nozzles and terminal ends.

The parabolic shapes 704a ... 707b are intended to represent air pressure profile differences for each of the pairs of nozzles measured or calculated at certain distances from the sorting nozzle assembly 201 (e.g., substantially along a longitudinal midplane 802 of an adjacent conveyor belt (e.g., the conveyor belt 103)). Air pressure profiles can be established mathematically or by taking air pressure readings (measurements) at various points along the air jet streams. The parabolic shapes 704a and 704b represent an exemplary first air pressure profile difference between the air jet cones 404a, 404b discharged from the nozzles 204a and 204b, respectively. For example, the parabolic shape 704a represents an exemplary first predetermined specific amount of air pressure discharged within the air jet cone 404a measured or calculated at a first certain distance (e.g., the midpoint 414a) from the nozzle 204a along the vector 714a, while the parabolic shape 704b represents that same exemplary first predetermined specific amount of air pressure discharged within the air jet cone 404b measured or calculated at a second certain distance (e.g., the midpoint 414b) from the nozzle 204b along the vector 714b. The parabolic shapes 705a and 705b represent an exemplary second air pressure profile difference between the air jet cones 405a, 405b discharged from the nozzles 205a and 205b, respectively. For example, the parabolic shape 705a represents an exemplary second predetermined specific amount of air pressure discharged within the air jet cone 405a measured or calculated at a certain first distance (e.g., the midpoint 415a) from the nozzle 205a along the vector 715a, while the parabolic shape 705b represents that same exemplary second predetermined specific amount of air pressure discharged within the air jet cone 405b measured or calculated at a second certain distance (e.g., the midpoint 415b) from the nozzle 205b along the vector 715b. The parabolic shapes 706a and 706b represent a third air pressure profile difference between the air jet cones 406a, 406b discharged from the nozzles 206a and 206b, respectively. For example, the parabolic shape 706a represents an exemplary third predetermined specific amount of air pressure discharged within the air jet cone 406a measured or calculated at a certain first distance (e.g., the midpoint 416a) from the nozzle 206a along the vector 716a, while the parabolic shape 706b represents that same exemplary third predetermined specific amount of air pressure discharged within the air jet cone 406b measured or calculated at a second certain distance (e.g., the midpoint 416b) from the nozzle 206b along the vector 716b. The parabolic shapes 707a and 707b represent an exemplary fourth air pressure profile difference between the air jet cones 407a, 407b discharged from the nozzles 207a and 207b, respectively. For example, the parabolic shape 707a represents an exemplary fourth predetermined specific amount of air pressure discharged within the air jet cone 407a measured or calculated at a certain first distance (e.g., the midpoint 417a) from the nozzle 207a along the vector 717a, while the parabolic shape 707b represents that same exemplary fourth predetermined specific amount of air pressure discharged within the air jet cone 407b measured or calculated at a second certain distance (e.g., the midpoint 417b) from the nozzle 207b along the vector 717b.

As can be seen, at an equal distance from each of the pairs of nozzles (for example, substantially along a longitudinal midplane 802 of an adjacent conveyor belt (e.g., the conveyor belt 103)), the respective air pressure profile differences of each pair of nozzles decreases from the pair of nozzles 204a, 204b to the pair of nozzles 207a, 207b. This is to demonstrate that the sorting nozzle assembly 201 may be configured so that a first subset of the nozzles (e.g., the first, or first and second, pair of nozzles) applies sufficient force towards material pieces on the conveyor belt selected for sorting to overcome the static friction between the conveyor belt and the selected material piece, and then a subsequent subset of the nozzles (e.g., the second, third, and/or fourth pair of nozzles) are configured to present air pressure profiles that are closer to each other (for example, in alignment) to continue to force the selected material piece off of the conveyor belt, but only have to overcome dynamic friction because the selected material piece has been placed in motion by the first subset of the nozzles. For example, with respect to a large and/or heavy material piece, the first set of nozzles (e.g., the pair of nozzles 204a, 204b) breaks free the material piece from its stationary position on the conveyor belt, and then the successive pairs of nozzles accelerate the material piece off the conveyor belt (towards the distal side of the conveyor belt) as the following pairs of nozzles are fired in succession. In other words, the sorting nozzle assembly 201 may be configured so that the pairs of nozzles are fired in a succession to effectively initiate displacement of the material piece from the conveyor belt and then to at least maintain that displacement to more effectively eject the material piece from the conveyor belt. Such a technique is further described with respect to FIGS. 9A-12B.

FIG. 8 illustrates an isometric view of the sorting nozzle assembly 201. The vectors 714a ... 717b and the terminal ends 724a ... 727b, which were introduced in FIG. 7, are also depicted. Additionally, in FIG. 8, three different imaginary planes are illustrated for purposes of describing features of the sorting nozzle assembly 201. Imaginary plane 801 represents the upper surface of a conveyor belt on which material pieces will be transported past the sorting nozzle assembly 201 to be presented in front of the sequence of nozzles (e.g., see FIG. 2B). Imaginary midplane 802 represents a longitudinal line along the direction of travel of the conveyor belt (e.g., the longitudinal centerline of the conveyor belt), which represents an exemplary predetermined location along the longitudinal length of the conveyor belt on which the material pieces 101 may be intended to be deposited and aligned onto the conveyor belt for classifying and sorting.

While embodiments of the present disclosure may be configured to deposit and align the material pieces to travel along the midplane 802 of the conveyor belt, alternative embodiments may be configured to offset the material piece alignment nearer to one side of the conveyor belt or the other. For example, if the material piece alignment offset is configured to be nearer toward the proximal side of the conveyor belt and thus nearer the sorting nozzle assembly 201, then the nozzle spray pattern may be configured to be smaller the nearer a material piece is to the nozzle tips of the sorting nozzle assembly 201, which may result in a more accurate targeting of each material piece. This could allow the material pieces to be deposited onto the conveyor belt closer together and/or reduce potential contamination resulting from blowing off unintended adjacent material pieces. Furthermore, because the nozzle spray patterns of each of the nozzles are condensed closer to the nozzle tips, the blow-off force is also more concentrated and will have greater ability to eject a material piece from the distal side of the conveyor belt. However, the ejected material pieces will have a farther distance across the conveyor belt to travel (e.g., see 211 in FIG. 2B) to clear the extent (i.e., the distal side) of the conveyor belt. If the material piece alignment offset is farther away from the sorting nozzle assembly 201 (and nearer to the distal side), then ejected material pieces do not have as far to travel (e.g., see 211 in FIG. 2B) to clear the extent (i.e., the distal side) of the conveyor belt into the desired receptacle. However, this could result in the nozzle spray pattern cones having to be configured much larger (and with greater air pressure) by the time they reach the targeted material pieces, which could mean the directed air jets may be less accurate (and thus the overall sorting process possibly more prone to contamination) as well as substantially weaker in force. Nevertheless, the material piece alignment offset along the conveyor belt may be adjusted as previously disclosed by the system designer in order to achieve a certain sorting performance.

Imaginary plane 803 demonstrates how the top row of nozzles 204a, 205a, 206a, 207a may be configured so that the vectors of their respective air jet cones are targeted to intersect plane 803 a predetermined distance D above the conveyor belt. For example, label 1311 represents an intersection of the plane 803 and the vector 714a of the air jet cone 404a discharged from the nozzle 204a, which may be predetermined to be a distance D above the intersection 1310 of the plane 801 and the plane 803 (see also FIG. 9B). In accordance with a non-limiting embodiment of the present disclosure, such a distance D may be predetermined to be a relative measurement parameter of one unit (e.g., 1 inch).

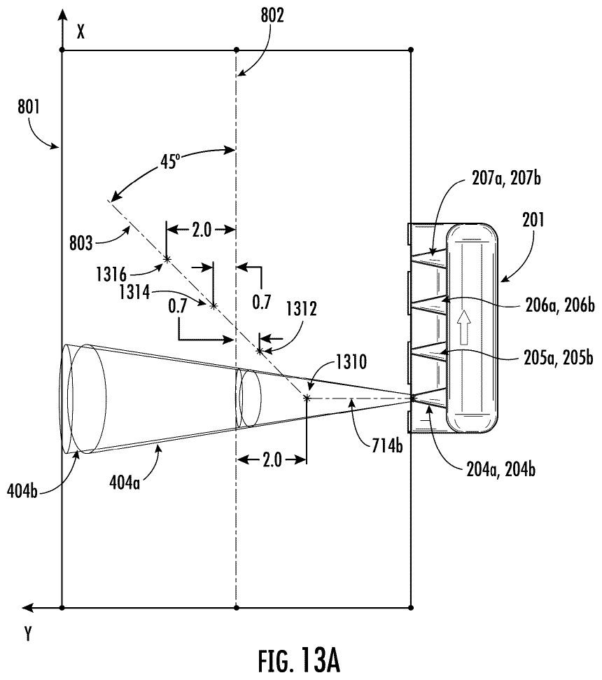

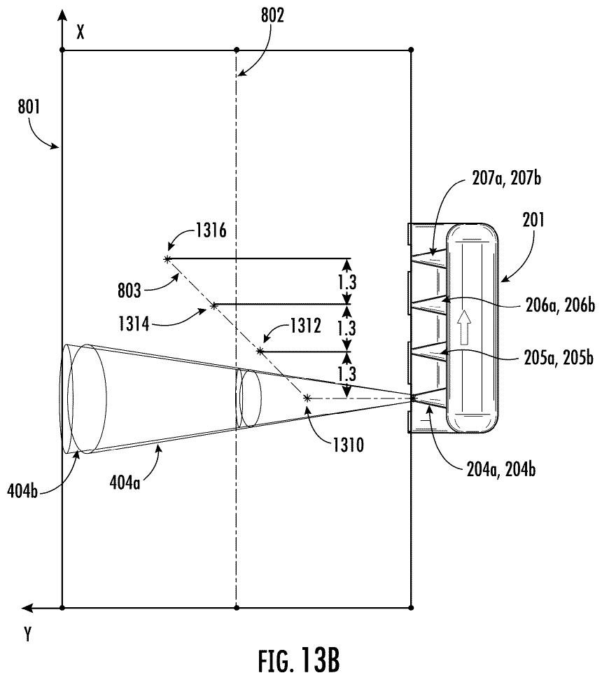

FIGS. 10B, 11B, 12B, and 13A-13B further illustrate these intersections between air jet cone vectors and the plane 803. The angle ⊖ between the planes 802 and 803 may be predetermined to achieve a desired succession of air jet blasts with desired targeting along the conveyor belt. In a non-limiting example, the angle ⊖ may be selected to be 45° (e.g., see FIG. 13A).

As can be readily appreciated by one skilled in the art, the vectors 714a ... 717b and the terminal ends 724a ... 727b can be utilized for configuring the various orientations (configurations) of the nozzles 204a ... 207b, and their respective applied air pressure profiles, to more efficiently and/or effectively divert selected material pieces from a conveyor belt for the purposes of sorting such material pieces. As can be readily appreciated by one skilled in the art, the nozzles 204a ... 207b may be configured so that a material piece 101 aligned on the conveyor belt 103 along the midplane 802 would be successfully displaced from the conveyor belt 103 by the successive activations of each pair of nozzles beginning with the nozzles 204a, 204b and ending with the nozzles 207a, 207b. For example, one or both of the nozzles 204a, 204b may be configured to project its air jet underneath, or to the side of, the material piece 101 to begin the displacement of the material piece 101, then the nozzles 205a, 205b are activated to further displace the material piece 101 transversely off of the conveyor belt 103 as the material piece 101 becomes farther displaced off of the conveyor belt 103 away from the sorting nozzle assembly 201 (i.e., in a direction from the proximal side to the distal side of the conveyor belt), then the nozzles 206a, 206b are activated to further displace the material piece 101 off of the conveyor belt 103 as the material piece 101 becomes further transversely displaced off of the conveyor belt 103 an even farther distance away from the sorting nozzle assembly 201, and then the nozzles 207a, 207b are activated to complete the ejection of the material piece 101 off of the conveyor belt 103.

FIGS. 9A-12B illustrate an exemplary sequencing of the activation, or firing, of the nozzle pairs within the sorting nozzle assembly 201 in accordance with certain embodiments of the present disclosure. The conveyor belt 103 and material pieces 101 deposited thereon are not shown in FIGS. 9A-12B for the sake of simplicity but may be referenced in FIG. 2B for the following disclosure. The arrow 210 is shown on each of FIGS. 9A, 10A, 11A, and 12A to indicate the direction by which the material pieces 101 will be transported on the conveyor belt 103 past the sorting nozzle assembly 201, such as further illustrated in FIG. 2B. It is readily apparent that, because of the continuing movement of the conveyor belt 103, a selected (classified) material piece 101 to be diverted from the conveyor belt 103 will first travel past the nozzles 204a, 204b, which are initially activated within such a sequence, and then the material piece 101 will then travel past the nozzles 205a, 205b as it is being transported on the moving conveyor belt 103 while also being further displaced transversely across the conveyor belt 103, and then the material piece 101 will then travel past the nozzles 206a, 206b as it is being transported on the moving conveyor belt 103 while also being further displaced transversely across the conveyor belt 103 towards its distal side, and then the material piece 101 will then pass the nozzles 207a, 207b as it is being transported on the moving conveyor belt 103 while also being further displaced transversely across the conveyor belt 103 even farther towards its distal side, with the intention of the foregoing firing sequence that the material piece 101 is then fully diverted off of (ejected from) the conveyor belt 103 by the activation of the nozzles 207a, 207b.

As shown in FIGS. 9A-12B, as a selected material piece 101 to be diverted/ejected from the conveyor belt 103 (e.g., in response to a classification of the selected material piece 101 as previously described herein) is transported within the proximity of the sorting nozzle assembly 201, the material handling system 100 will send a control signal (e.g., from the automation control system 108 as described with respect to FIG. 1), which will activate a firing sequencing of at least a subset of the nozzles 204a ... 207b within the sorting nozzle assembly 201 to divert/eject the material piece 101 from the conveyor belt 103. Though embodiments of the present disclosure are described with respect to a firing sequence of all of the nozzles 204a ... 207b, alternative embodiments of the present disclosure may implement a firing sequence of a subset of less than all of the nozzles 204a ... 207b, which may include activating such a subset of the nozzles for material pieces having a certain size or shape.

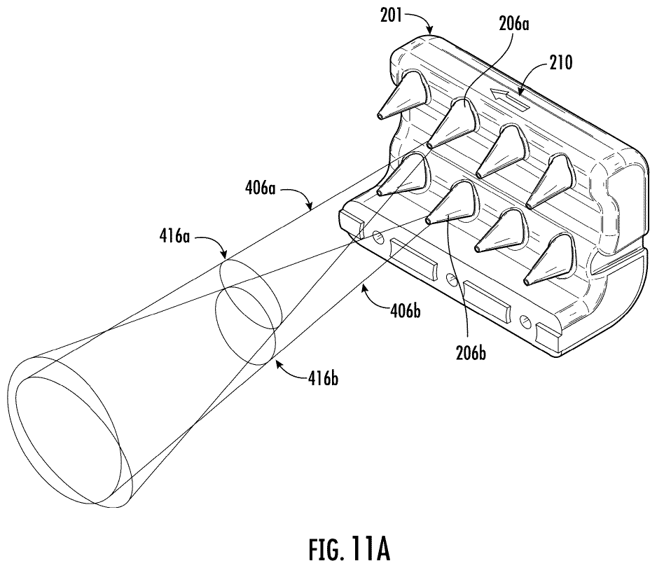

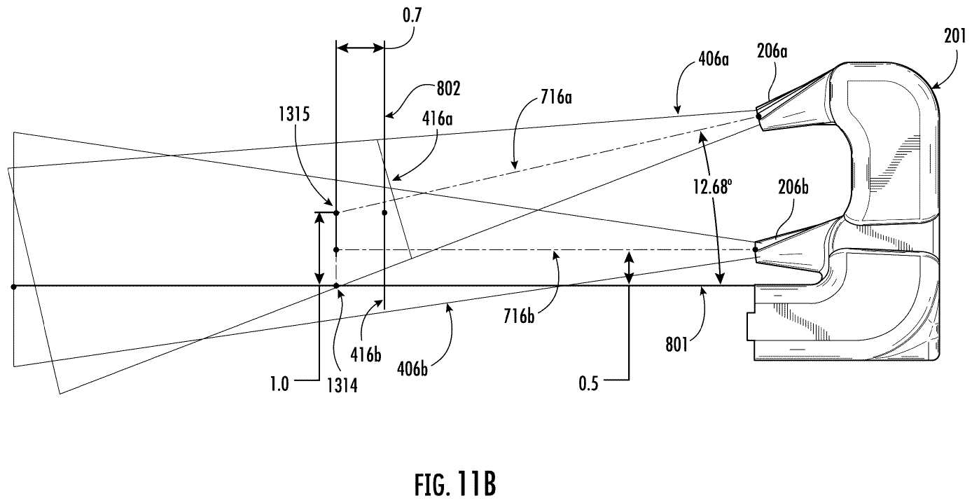

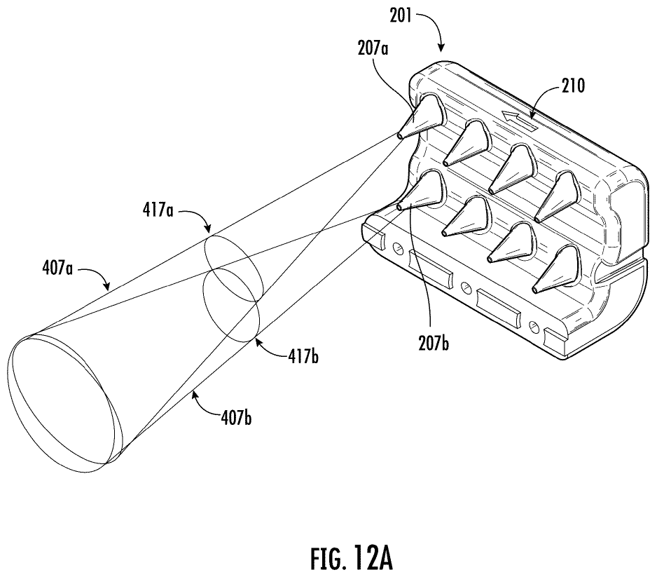

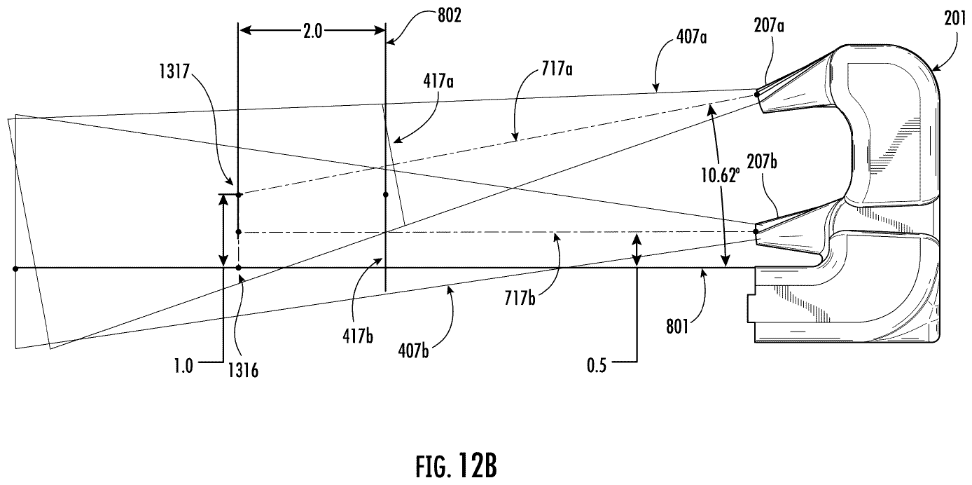

FIG. 9A illustrates an isometric view of the sorting nozzle assembly 201, while FIG. 9B illustrates a side view of the sorting nozzle assembly 201, both showing activation of the air jets 404a, 404b from the nozzles 204a, 204b, respectively, as the first nozzle pair to be activated within the firing sequence (e.g., when the selected material piece 101 is passing by the nozzle pair 204a, 204b). FIG. 10A illustrates an isometric view of the sorting nozzle assembly 201, while FIG. 10B illustrates a side view of the sorting nozzle assembly 201, both showing the activation of the air jets 405a, 405b from the nozzles 205a, 205b, respectively, as the second nozzle pair to be activated within the firing sequence (e.g., when the selected material piece 101 is passing by the nozzle pair 205a, 205b). FIG. 11A illustrates an isometric view of the sorting nozzle assembly 201, while FIG. 11B illustrates a side view of the sorting nozzle assembly 201, both showing the activation of the air jets 406a, 406b from the nozzles 206a, 206b, respectively, as the third nozzle pair to be activated within the firing sequence (e.g., when the selected material piece 101 is passing by the nozzle pair 206a, 206b). FIG. 12A illustrates an isometric view of the sorting nozzle assembly 201, while FIG. 12B illustrates a side view of the sorting nozzle assembly 201, both showing the activation of the air jets 407a, 407b from the nozzles 207a, 207b, respectively, as the fourth nozzle pair to be activated within the firing sequence (e.g., when the selected material piece 101 is passing by the nozzle pair 207a, 207b). The timing of the firing sequence will depend upon the predetermined speed of the conveyor belt.

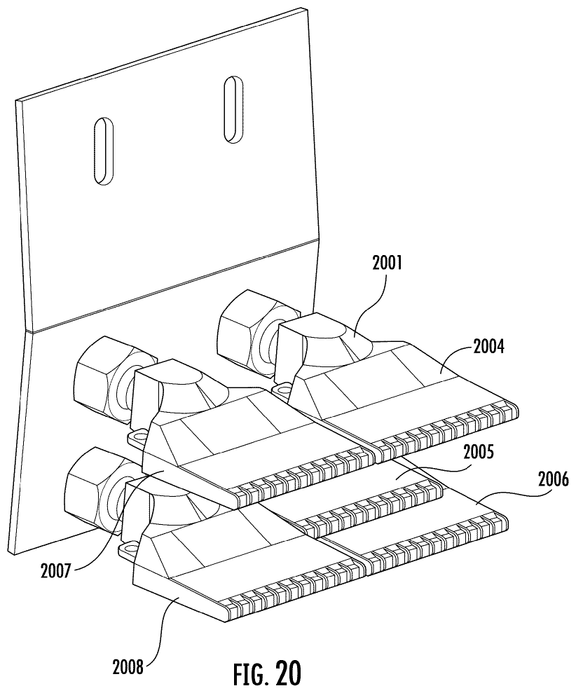

Though the firing sequence disclosed with respect to FIGS. 9A-12B is illustrated with the nozzles 204a ... 207b and their respective applied air pressure profiles as shown in FIGS. 2A-8, such a firing sequence may be implemented with a sorting nozzle assembly having a differently configured array of nozzles (e.g., the sorting nozzle assembly 2001 illustrated in FIG. 20).

As previously described with respect to FIGS. 4-6, the nozzles 204a and 204b may be configured so that their respective vectors 714a and 714b may be directed at angles so that their respective air jets 404a and 404b more effectively initiate the diversion of a selected material piece 101 from the conveyor belt 103, including being more effective at commencing movement of any material pieces 101 that may have a flatter or lower profile. For example, the nozzles 204a and 204b may be configured so that their respective air jets 404a and 404b apply a sufficient force towards a selected material piece 101 on the conveyor belt 103 to overcome the static friction between the conveyor belt 103 and the material piece 101. As shown in FIG. 9B, one or both of the nozzles 204a, 204b may be configured so that their respective vectors 714a, 714b are angled relative to the horizontal plane 801 of the conveyor belt so that the focal point(s) of the air jet(s) 404a, 404b is projected underneath the selected material piece 101. For example, in accordance with certain embodiments of the present disclosure, the nozzle 204b may be configured (i.e., angled downward from the horizontal) so that the vector 714b of the air jet cone 404b is aimed at a focal point (target location) 1310 on the conveyor belt surface that is a predetermined distance from the midplane 802 (see also FIGS. 13A-13B) while the nozzle 204a may be configured so that the vector 714a of the air jet cone 404a is aimed more towards the expected position of the material piece 101 on the conveyor belt 103 (e.g., along the midplane 802). In a non-limiting example, such an angle for the vector 714a may be predetermined to be about 20.56°, and the angle for the vector 714b may be predetermined to be about 7.13° in order to achieve a predetermined distance of the target location 1310 from the midplane 802 (e.g., shown with a distance parameter of 2.0 in FIG. 9B). Nevertheless, the position of this target location 1310 may be predetermined as a function of the known typical sizes of the material pieces to be sorted from the conveyor belt. For example, if sizes of the material pieces are known to typically average about 4 inches in diameter, the target location 1310 may be predetermined to be 2 inches nearer to the sorting nozzle assembly 201 from the midplane 802 of the conveyor belt (which is the longitudinal line on which the material pieces are expected to be deposited and aligned) so that a stronger blow-off force of the air jet 204b is directed at a near edge of such a typical material piece to thereby lift the material piece up from the surface of the conveyor belt. This can be advantageous for ejecting material pieces having a relatively flatter profile.

The nozzle 204a may be configured (i.e., angled downward from the horizontal) so that the vector 714a of the air jet cone 404a is aimed at a target location 1311 that is predetermined to be a certain distance D above (in the Z direction from the plane 801) the target location 1310. This target location 1311 may be predetermined as a function of the known typical sizes of the material pieces to be sorted from the conveyor belt. For example, if the material piece sizes are known to typically average about four inches in diameter, this target location 1311 may be selected so that the air jet 404a is directed to provide a stronger blow-off force to a side of such a typical material piece (while the air jet 404b is lifting the material piece up from the surface of the conveyor belt). Moreover, such a combined actuation, or firing, of the air jets 404a, 404b first in the aforementioned firing sequence may thus more effectively initiate the removal of material pieces, especially since the nozzles 204a, 204b are aimed to have a stronger blast of their pressurized air contact the side and underside, respectively, of material pieces positioned along the midplane 802 of the conveyor belt.

Thus, in accordance with embodiments of the present disclosure, a sorting nozzle assembly may be configured to have one or more of the first nozzles to be fired in the aforementioned sequence to be directed at such closer focal point(s) for more effectively ejecting material pieces having flatter profiles and/or provide a stronger initial air blast to begin the removal of a selected material piece from the surface of the conveyor belt, including material pieces having relatively larger masses than typical material pieces.

Correspondingly, one or more of the other various nozzles may be configured so that the vectors of their respective air jets are angled (e.g., in a more horizontal manner parallel to the conveyor belt surface) to complete the ejection of the material piece 101 from the conveyor belt 103, since such a material piece 101 will have been lifted up from the surface of the conveyor belt and will already be beginning to tumble off of the surface of the conveyor belt 103 at a height above the surface of the conveyor belt 103 (i.e., to continue to force the material piece 101 off of the conveyor belt 103 so as to overcome dynamic friction because the material piece 101 has been placed in motion by the air jets 404a and 404b).

Referring to FIGS. 10B, 11B, and 12B, the nozzles 205b, 206b, and 207b may be configured so that their respective air jets are aimed with their vectors 715b, 716b, and 717b, respectively, substantially parallel to the surface 801 of the conveyor belt 103 at a predetermined height above the surface 801 of the conveyor belt 103 (e.g., in a non-limiting exemplary embodiment, 0.5 inches for four-inch average material pieces), and parallel to each other transversely across the conveyor belt surface. They may be configured as such since these nozzles may be designed to continue the displacement of a material piece since the material piece has now been lifted above the surface of the conveyor belt by the action of the air jets 404a, 404b. The nozzles 205a, 206a, and 207a may be configured so that they are aimed in a manner that their vectors 715a, 716a, and 717a, respectively, are directed to be a predetermined height D above predetermined target locations 1312, 1314, and 1316, respectively, at longitudinal intervals down the conveyor belt 103. These predetermined intervals may be selected to be a predetermined distance between each other, such as illustrated in FIGS. 13A-13B.

The predetermined height D above the conveyor belt may be dependent upon the expected flight pattern of a typical material piece as it is being ejected by the sequence of activated air jets. In accordance with a non-limiting example of the present disclosure, such a distance for the target locations 1313, 1315, and 1317 may be about one inch above the surface 801 of the conveyor belt 103. However, any other distance or height above the conveyor belt may be selected, depending upon the experimental analysis of the typical interactions of material pieces and the air jets. Moreover, in accordance with alternative embodiments of the present disclosure, one or more of the various nozzles 204a ... 207b may be adjustable so that their respective angles can be configured more effectively for ejecting certain types of material pieces.

For example, in accordance with non-limiting embodiments of the present disclosure, an angle for the vector 715a of the nozzle 205a may be about 15.71°, while the angle for the vector 715b of the nozzle 205b may be about 0° (i.e., substantially parallel to the conveyor belt surface 801), such as shown in FIG. 10B; an angle for the vector 716a of the nozzle 206a may be about 12.68°, while the angle for the vector 716b of the nozzle 206b may be about 0° (i.e., substantially to the conveyor belt surface), such as shown in FIG. 11B; and an angle for the vector 717a of the nozzle 207a may be about 10.62°, while the angle for the vector 717b of the nozzle 207b may be about 0° (i.e., substantially to the conveyor belt surface), such as shown in FIG. 12B. These angles may be predetermined to achieve a selected air jet spray pattern from the array of the nozzles 204a ... 207b as described within various embodiments disclosed herein. For instance, as shown in FIG. 10B, the nozzle 205 a may be configured so that the angle for the vector 715a is selected (predetermined) to project a specified air pressure of the air jet 405a towards the selected material piece at the target location 1313 a specified distance from the midplane 802, which in a non-limiting exemplary embodiment may be predetermined to be about 0.7 inches from the midplane 802 at a height of about 1.0 inch above the surface 801 of the conveyor belt; as shown in FIG. 11B, the nozzle 206a may be configured so that the angle for the vector 716a is selected (predetermined) to project a specified air pressure of the air jet 406a towards the selected material piece at the target location 1315 a specified distance from the midplane 802, which in a non-limiting exemplary embodiment may be predetermined to be about 0.7 inches from the midplane 802 at a height of about 1.0 inch above the surface 801 of the conveyor belt; and as shown in FIG. 12B, the nozzle 207a may be configured so that the angle for the vector 717a is selected (predetermined) to project a specified air pressure of the air jet 407a towards the selected material piece at the target location 1317 a specified distance from the midplane 802, which in a non-limiting exemplary embodiment may be predetermined to be about 2.0 inches from the midplane 802 at a height of about 1.0 inch above the surface 801 of the conveyor belt.

Nevertheless, selection of such specific angles may be dependent upon the relative overall dimensions of the material handling system, including the width of the conveyor belt, its travel speed, the expected sizes, shapes, and/or masses of the material pieces, the pitch between the nozzles in the sorting nozzle assembly, the height difference between pairs of nozzles, the amount of pressurized air delivered to the sorting nozzle assembly and ejected from the nozzles, the desired overlap between adjacent nozzles, etc.

FIGS. 13A-13B illustrate a top-down view of the sorting nozzle assembly 201 positioned adjacent to a surface of a conveyor belt 801 in accordance with embodiments of the present disclosure. FIGS. 13A-13B further depict a progressive blow off or ejection of a selected material piece from the conveyor belt using the aforementioned firing sequence as the material piece travels along the conveyor belt (longitudinally in the X direction) past the sorting nozzle assembly 201. The imaginary plane 803 is depicted along with the spacing of the target locations (focal points) for the vectors of the air jet cones projected from each pair of nozzles. For the sake of simplicity, only the air jet cones 404a and 404b are illustrated.

FIGS. 13A-13B show the target locations 1310, 1312, 1314, and 1316 and their positioning relative to the midplane 802, as previously described with respect to FIGS. 9B, 10B, 11B, and 12B. In accordance with a non-limiting embodiment of the present disclosure, the plane 803 along which the target locations are positioned may be configured at an angle ⊖ (e.g., 45°) relative to the midplane 802, though such an angle may depend upon the predetermined speed of the conveyor belt. The target location 1310 may also be referred to herein as positioned at coordinates X₁, Y₁ on the plane 801 relative to the sorting nozzle assembly 201; the target location 1312 may also be referred to herein as positioned at coordinates X₂, Y₂ on the plane 801 relative to the sorting nozzle assembly 201; the target location 1314 may also be referred to herein as positioned at coordinates X₃, Y₃ on the plane 801 relative to the sorting nozzle assembly 201; and the target location 1316 may also be referred to herein as positioned at coordinates X₄, Y₄ on the plane 801 relative to the sorting nozzle assembly 201.

FIG. 13B illustrates an exemplary distance between the target locations longitudinally along the surface 801 of the conveyor belt 103, which may be evenly spaced (e.g., based on the predetermined pitch between the pairs of nozzles (see 580 in FIG. 5)), though they may have different spacing dependent upon previously observed characteristics of the ejection flight patterns of typical material pieces. FIGS. 13A-13B readily demonstrate how the target locations of the nozzle pairs successively extend a greater distance from the sorting nozzle assembly 201 (transversely across the conveyor belt in the Y direction from the proximal side to the distal side) as each pair of nozzles are fired in the aforementioned firing sequence depicting how such a firing sequence of nozzles is configured to project the sequence of air blasts at a selected material piece as it continues to travel longitudinally past the sorting nozzle assembly 201 to promote its ejection from the surface 801 of the conveyor belt 103.

The specific dimensions illustrated in FIGS. 13A-13B, which are to be non-limiting, were selected based on an average size of four inches for the material pieces. Thus, such dimensions may be modified as a function of the expected average piece size of material pieces to be sorted. As can be readily apparent, the designer of the material handling system (e.g., the material handling system 100) can predetermine the positioning of the target locations as a function of various parameters, including, but not limited to, the conveyor belt speed, the size, shape, and/or mass of an average material piece, the width of the conveyor belt, the heights of the various nozzles above the plane 801, the number N of nozzles within the sorting nozzle assembly 201, the magnitude of air pressure delivered to the sorting nozzle assembly 201 and the subsequent air pressure of the air jets projected from the various nozzles, the shapes of the air jets, a relative friction inherent in the conveyor belt surface, the pitch 580 and the overlap 590, whether the first pair of nozzles are aimed to lift the material pieces from the conveyor belt surface, etc. And, consequently, the selection of the target locations along with the foregoing parameters may then determine the various vector angles configured for the nozzles.

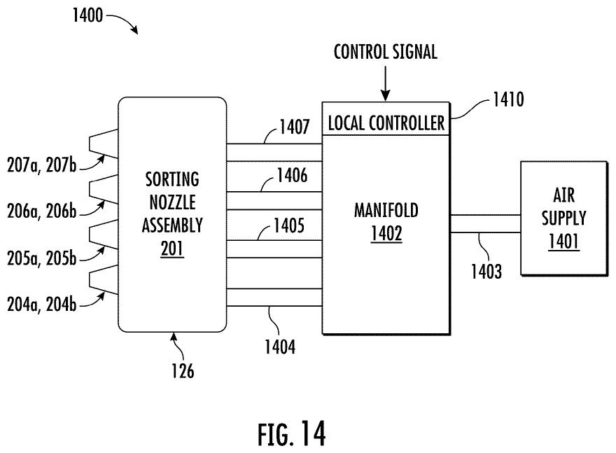

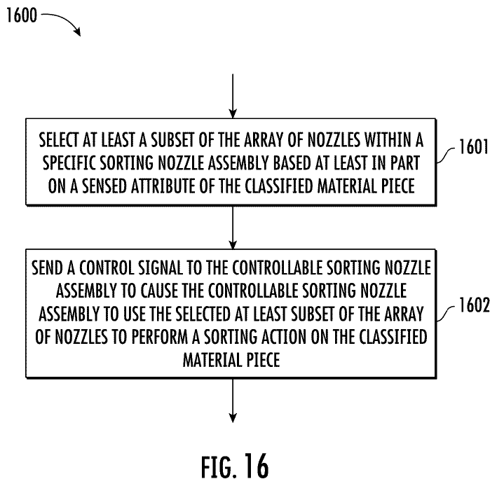

FIG. 14 illustrates a sorting nozzle assembly system 1400 configured in accordance with embodiments of the present disclosure. The sorting nozzle assembly system 1400 may be implemented within any material handling and/or sorting system including, but not limited to, the material handling system 100. The sorting nozzle assembly 201 may receive pressurized air from a pressurized air supply 1401 via a pressure line 1403 that supplies a manifold 1402, which controls the supply of pressurized air to each of the pairs of nozzles within the sorting nozzle assembly 201. For example, the manifold 1402 may include well-known valves that are selectable utilizing actuators (e.g., solenoid actuators, not shown) in a well-known manner to divide and control the supply of the pressurized air from the pressure line 1403 to each of the conduits 1404, 1405, 1406, and 1407, which supply each of the pairs of nozzles 204a and 204b, 205a and 205b, 206a and 206b, 207a and 207b, respectively. In some embodiments, at least some of the nozzles 204a ... 207b have orifices that are connected to the conduits 1404 ... 1407, such as described with respect to FIG. 18. Coupled to the manifold 1402 is a local controller 1410, which may be implemented with any well-known control circuitry (e.g., process or microcontroller) for receiving a control signal from the automation control system 108. The supply of pressurized air to the orifices may be controlled by the local controller 1410, which is configured to cause pressurized air to be emitted from the orifices according to various embodiments of the present disclosure. The manifold 1402 may include a pressure level adjustment system or apparatus (not shown) arranged to control the pressure of the gaseous or liquid media supplied to the plurality of nozzles. For example, the pressure level adjustment means may be arranged to increase and/or decrease the pressure level of the supplied gaseous or liquid media. The pressure level adjustment system or apparatus may be any well-known valve controllable by the local controller 1410. An exemplary operation of the sorting nozzle assembly system 1400 is further described with reference to FIG. 16.

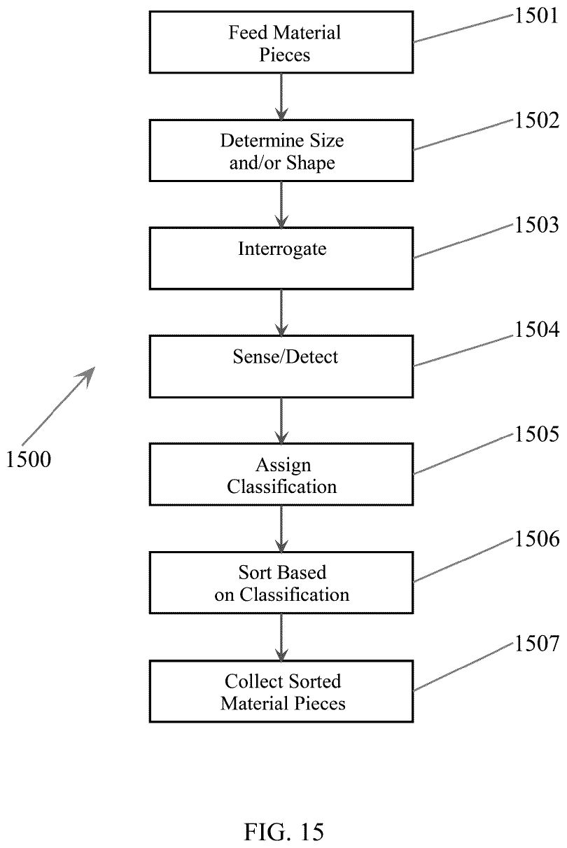

FIG. 15 illustrates a flowchart diagram depicting exemplary embodiments of a process 1500 for classifying and sorting material pieces in accordance with certain embodiments of the present disclosure. The process 1500 may be configured to operate within any of the embodiments of the present disclosure described herein, including the material handling system 100 of FIG. 1.

Aspects of the operation of the process 1500 may be performed by hardware and/or software, including within a computer system (e.g., the sensor control 123 and/or the computer system 107 of FIG. 1). In the process block 1501, material pieces (e.g., material pieces 101) are fed along a conveyor system (e.g., a conveyor belt 103). Next, in the optional process block 1502, the material pieces may be conveyed along the conveyor system within proximity of a material piece tracking device, profilometer, and/or an optical imaging system in order to track each material piece and/or determine a size and/or shape of the material pieces. In the process block 1503, when a material piece has traveled in proximity of a vision system and/or sensor system, images of the material piece may be captured by the vision system or the material piece may be interrogated, or stimulated, with EM energy (waves) or some other type of stimulus appropriate for the particular type of sensor technology utilized by the sensor system. In the process block 1504, physical characteristics or attributes of the material piece are sensed/detected/captured. In the process block 1505, the type of material is identified/classified based on the sensed/detected/captured characteristics/attributes. Next, in the process block 1506, a sorting device (e.g., the sorting nozzle assembly 201) corresponding (i.e., mapped or assigned) to the classification of the material piece is activated. Between the time at which the material piece was sensed and the time at which the sorting device is activated, the material piece has moved from the proximity of the vision/sensor system to a location longitudinally downstream on the conveyor system, at the rate of conveying of the conveyor system. In certain embodiments of the present disclosure, the activation of the sorting device is timed such that as the material piece passes the sorting device mapped to the classification of the material piece, the sorting device is activated, and the material piece is diverted/ejected from the conveyor system into its associated sorting receptacle (or onto another conveyor belt). Within certain embodiments of the present disclosure, the activation of a sorting device may be timed by a respective position detector that detects when a material piece is passing before the sorting device and sends a signal to enable the activation of the sorting device. Activation of the sorting device may be performed by the sending of an appropriate control signal from the automation control system 108 to the appropriate sorting device (i.e., a sorting nozzle assembly 201). In the process block 1507, the sorting receptacle (or another conveyor belt) corresponding to the sorting device that was activated receives the diverted/ejected material piece.

FIG. 16 illustrates a flowchart diagram of a process 1600 configured for using the sorting nozzle assembly system 1400 in a controllable manner in accordance with certain embodiments of the present disclosure, wherein the process 1600 is repeated as material pieces move along on a conveyor system and new sensed attributes are generated based on the current material pieces that are located on the conveyor system. A non-limiting example of such a controllable manner may be the firing sequence previously described with respect to FIGS. 9A-12B. The process 1600 may be implemented within the automation control system 108 to generate the control signal to send to the sorting nozzle assembly system 1400.

In the process block 1601, at least a subset of the array of nozzles within the sorting nozzle assembly 201 is selected based at least in part on a sensed attribute of a material piece that has been classified in the process block 1505 to be used to perform a sorting action on the classified material piece. In certain embodiments, the subset of the array of nozzles within the sorting nozzle assembly 201 may be selected based on an attribute (e.g., a geometry, size, shape, approximate mass) of the classified material piece and/or a location of the material piece on the conveyor belt. In accordance with certain embodiments of the present disclosure, a duration of time for which the selected at least subset of nozzles is to perform the sorting action on the material piece is also determined based at least in part on an attribute (e.g., a geometry, size, shape, approximate mass) of the material piece.

In the process block 1602, an instruction (e.g., a control signal) is sent to the sorting nozzle assembly system 1400 to cause the sorting nozzle assembly 201 to use the selected at least subset of the array of nozzles to perform a sorting action on the material piece. In accordance with certain embodiments of the present disclosure, the instruction specifies the selected at least subset of the array of nozzles to use to perform the sorting action, the duration of time for which to perform the sorting action, a firing sequence for activation of the selected at least subset of the array of nozzles, a time or other temporal element for when to (start to) perform the sorting action, and/or a degree of force (e.g., an amount of pressurized air to supply to each of the nozzles) to use in performing the sorting action.

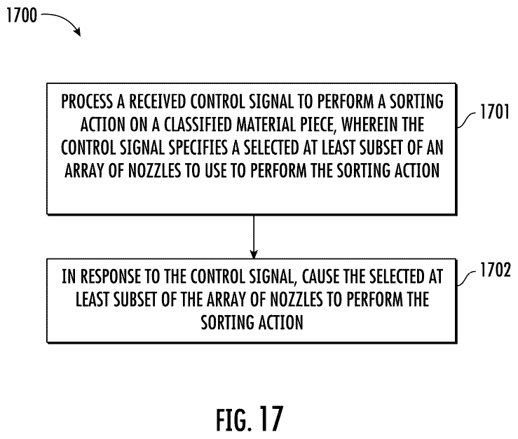

FIG. 17 illustrates a flowchart diagram of a process 1700 configured for performing a sorting action by the sorting nozzle assembly system 1400 in accordance with certain embodiments of the present disclosure. In some embodiments, the process 1700 may be implemented, at least in part, in the local controller 1410. In the process block 1701, an instruction to perform a sorting action on a classified material piece is received and processed, wherein the instruction specifies a selected at least subset of the array of nozzles within the sorting nozzle assembly 201 to use to perform the sorting action. In accordance with certain embodiments of the present disclosure, the instruction may be generated using a process such as the process 1600. In accordance with certain embodiments of the present disclosure, the instruction may be generated by a processor that is local to the sorting nozzle assembly system 1400. In accordance with certain embodiments of the present disclosure, the instruction may be received from a processor that is remote to the sorting nozzle assembly system 1400 (e.g., the automation control system 108). In accordance with certain embodiments of the present disclosure, the instruction may specify which specific nozzles to use to perform the sorting action of diverting the classified material piece from the conveyor belt. In accordance with certain embodiments of the present disclosure, the instruction may specify a duration of time for which to perform the sorting action. In accordance with certain embodiments of the present disclosure, the instruction may specify a degree of force (e.g., the pressure of the airflows that are to be emitted from diverting mechanisms that are air orifices) to use to perform the sorting action. In accordance with certain embodiments of the present disclosure, the instruction may specify a time, start/stop control signal, or other temporal related element for which the sorting nozzle assembly system 1400 is to perform the sorting action. In accordance with certain embodiments of the present disclosure, the instruction may specify a firing sequence for activation of the selected at least subset of the array of nozzles (e.g., the firing sequence as described with respect to FIGS. 9A-12B).

In the process block 1702, in response to the instruction, the selected at least subset of the array of nozzles within the sorting nozzle assembly 201 is caused to perform the sorting action on the classified material piece. The selected at least subset of the array of nozzles within the sorting nozzle assembly 201 is activated to perform the sorting action on the classified material piece in accordance with the zero or more other specified parameters of the instruction. For example, the selected at least subset of the nozzles would emit pressurized air jets to divert the classified material piece from the conveyor belt.

FIG. 18 illustrates a cross-sectional view of the sorting nozzle assembly 201 along lines A-A′ of FIG. 7, illustrating the internal nozzle conduits, configured in accordance with embodiments of the present disclosure, for supplying pressurized air to the nozzles 204a, 204b from an external supply (see FIG. 14). An inlet 1803a formed within the body of the sorting nozzle assembly 201 receives pressurized air (e.g., from conduit 1404) at a selected time (e.g., coinciding with the passage of a material piece on the conveyor belt past the sorting nozzle assembly 201 so as to divert the material piece from the conveyor belt). The outlets 1814a, 1814b are formed within the air jet tips of the nozzles 204a, 204b, respectively, for discharging (projecting) the pressurized air towards a material piece to be sorted. The inlet 1803a is in fluid communication with the internal conduits 1804a, 1804b extending between the inlet 1803a and each of the outlets 1814a, 1814b, respectively. The internal dimensions of the internal conduits 1804a, 1804b and/or the outlets 1814a, 1814b may be configured/designed to certain specifications for discharging the air from each of the outlets 1814a, 1814b at a predetermined pressure. In accordance with embodiments of the present disclosure, the configuration illustrated in FIG. 18 can represent the same for the other pairs of nozzles within the sorting nozzle assembly 201.

In accordance with embodiments of the present disclosure, the air conduits 1804a, 1804b may be designed as illustrated in FIG. 18 to provide for a more efficient flow of air to each of their respective nozzles 204a, 204b, thereby increasing the response time, increasing laminar flow for a more precise stream versus a turbulent flow (i.e., that spreads rapidly), and reducing the required air pressure to overcome internal flow losses within the conduits. The generation of compressed air requires energy. Since the energy costs account for an increasingly large share of the overall costs of a sorting process, considerable savings can be achieved through the right nozzle selection. The air conduits 1804a, 1804b are designed so that they need less compressed air than conventional nozzles, without compromising performance.

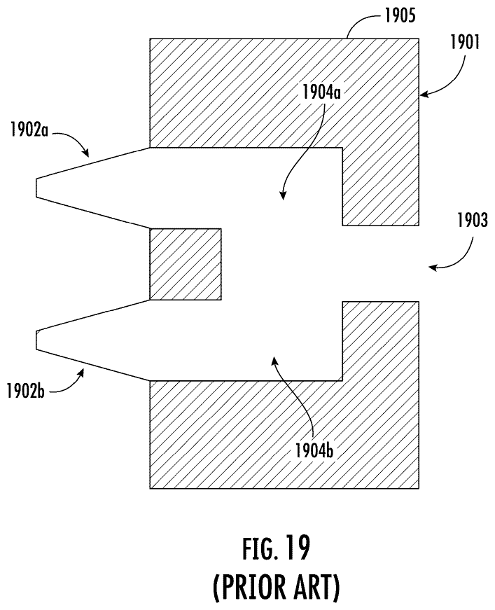

As illustrated by the prior art sorting nozzle assembly 1901 of FIG. 19, with conventional nozzles 1902a, 1902b, pressurized air is simply blown through a cavity machined within a metal body 1905 having sharp angles possessed by the machined internal conduits 1903, 1904a, and 1904b. The turbulence produced by such sharp angles creates loud hissing noises.

In contrast, the air conduits 1804a, 1804b reduce this turbulence. The specially shaped air conduits 1804a, 1804b more smoothly guide the supplied air uniformly to ensure optimum flow behavior. This produces a uniform, aligned, and powerful air jet stream. The decrease in turbulence results in lower noise emissions and also measurably reduces air consumption. As previously described herein, the internal conduits 1804a, 1804b, 1814a, 1814b may be formed by any well-known manufacturing technique, including utilizing 3-D printing of the sorting nozzle assembly 201.

While the nozzles, the sorting nozzle assembly, and the sorting nozzle assembly system are illustrated as having particular configurations, one skilled on the art will recognize that such nozzles, sorting nozzle assembly, and/or sorting nozzle assembly system may include more or fewer components of different types (e.g., see the sorting nozzle assembly 2001 of FIG. 20). Indeed, one skilled in the art will recognize that the material handling system 100 illustrated in FIG. 1 has been constructed to illustrate an example set-up of a sorting system in accordance with embodiments of the present disclosure, and therefore is presented by way of illustration and not by way of limitation. For example, the sorting nozzle assembly 201 illustrated in FIGS. 2A-12B may be configured/designed in various ways (e.g., with a larger or a smaller number of nozzles). In addition, the dimensions and relative orientations (angles) of the nozzles disclosed in FIGS. 2A-12B may be altered depending on the pressure of gaseous media provided to the sorting nozzle assembly 201, as well as the type and size of objects to be sorted when the nozzles are arranged as an array in the sorting nozzle assembly 201 and used in a system for sorting objects.

In accordance with alternative embodiments of the present disclosure, a sorting nozzle assembly may be configured with nozzles oriented to only blow onto areas of the conveyor belt where material pieces are expected to be. In accordance with alternative embodiments of the present disclosure, the firing sequence may be dynamically modified or adjusted to compensate for material piece sizes that are different than other material pieces, such as for longer material pieces, which would entail the nozzles to fire on the longer material piece for an extended period of time.

In accordance with alternative embodiments of the present disclosure, a sorting system may be configured with separate additional sorting nozzle assemblies for blowing off specifically known shapes of material pieces to more effectively eject them from a surface of the conveyor belt.

FIG. 20 illustrates an isometric view of a sorting nozzle assembly 2001 configured in accordance with alternative embodiments of the present disclosure. The sorting nozzle assembly 2001 is shown with five separate nozzles 2004 ... 2008 but may be configured with any number N (N>1) such nozzles. The nozzles 2004 ... 2008 are configured as well-known blade nozzles each having a plurality of orifices arranged in a row. Each of the nozzles 2004 ... 2008 may be supplied with a separate controllable source of pressurized air similar to the nozzles 204a ... 207b of the sorting nozzle assembly 201. Furthermore, one or more of the nozzles 2004 ... 2008 may be actuated to eject respective air blasts in accordance with a predetermined sequence similar to the firing sequence described with respect to FIGS. 9A-12B. Additionally, one or more of the nozzles 2004 ... 2008 may be configured to direct their respective air blasts along vectors at different predetermined angles towards predetermined target locations of the adjacent conveyor belt (not shown) as similarly described with respect to the sorting nozzle assembly 201.

As will be appreciated by one skilled in the art, aspects of the present disclosure may be embodied as a system, process, method, and/or program product. Accordingly, various aspects of the present disclosure may take the form of an entirely hardware embodiment, an entirely software embodiment (including firmware, resident software, micro-code, etc.), or embodiments combining software and hardware aspects, which may generally be referred to herein as a “circuit,” “circuitry,” “module,” or “system.” Furthermore, aspects of the present disclosure may take the form of a program product embodied in one or more computer readable storage medium(s) having computer readable program code embodied thereon. (However, any combination of one or more computer readable medium(s) may be utilized. The computer readable medium may be a computer readable signal medium or a computer readable storage medium.)

A computer readable storage medium may be, for example, but not limited to, an electronic, magnetic, optical, electromagnetic, infrared, biologic, atomic, or semiconductor system, apparatus, controller, or device, or any suitable combination of the foregoing, wherein the computer readable storage medium is not a transitory signal per se. More specific examples (a non-exhaustive list) of the computer readable storage medium may include the following: an electrical connection having one or more wires, a portable computer diskette, a hard disk, a random access memory (“RAM”), a read-only memory (“ROM”), an erasable programmable read-only memory (“EPROM” or flash memory), an optical fiber, a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, controller, or device. Program code embodied on a computer readable signal medium may be transmitted using any appropriate medium, including but not limited to wireless, wire line, optical fiber cable, RF, etc., or any suitable combination of the foregoing.

The flowchart and block diagrams in the figures illustrate architecture, functionality, and operation of possible implementations of systems, methods, processes, and program products according to various embodiments of the present disclosure. In this regard, each block in the flowcharts or block diagrams may represent a module, segment, or portion of code, which includes one or more executable program instructions for implementing the specified logical function(s). It should also be noted that, in some implementations, the functions noted in the blocks may occur out of the order noted in the figures. For example, two blocks shown in succession may, in fact, be executed substantially concurrently, or the blocks may sometimes be executed in the reverse order, depending upon the functionality involved.

It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. For example, a module may be implemented as a hardware circuit including custom VLSI circuits or gate arrays, off-the-shelf semiconductors such as logic chips, transistors, controllers, or other discrete components. A module may also be implemented in programmable hardware devices such as field programmable gate arrays, programmable array logic, programmable logic devices, or the like.

Reference is made herein to “configuring” a device or a device “configured to” perform some function. It should be understood that this may include selecting predefined logic blocks and logically associating them, such that they provide particular logic functions, which includes monitoring or control functions. It may also include programming computer software-based logic of a retrofit control device, wiring discrete hardware components, or a combination of any or all of the foregoing. Such configured devices are physically designed to perform the specified function or functions.

In the descriptions herein, numerous specific details are provided, such as examples of programming, software modules, user selections, predetermined parameters (e.g., lengths, distances, angles, material piece sizes, etc.) hardware modules, hardware circuits, hardware chips, controllers, etc., to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations may be not shown or described in detail to avoid obscuring aspects of the disclosure.

Reference throughout this specification to “an embodiment,” “embodiments,” or similar language means that a particular feature, structure, or characteristic described in connection with the embodiments is included in at least one embodiment of the present disclosure. Thus, appearances of the phrases “in one embodiment,” “in an embodiment,” “embodiments,” “certain embodiments,” “various embodiments,” and similar language throughout this specification may, but do not necessarily, all refer to the same embodiment. Furthermore, the described features, structures, aspects, and/or characteristics of the disclosure may be combined in any suitable manner in one or more embodiments. Correspondingly, even if features may be initially claimed as acting in certain combinations, one or more features from a claimed combination can in some cases be excised from the combination, and the claimed combination can be directed to a sub-combination or variation of a sub-combination.

Benefits, advantages, and solutions to problems have been described above with regard to specific embodiments. However, the benefits, advantages, solutions to problems, and any element(s) that may cause any benefit, advantage, or solution to occur or become more pronounced may be not to be construed as critical, required, or essential features or elements of any or all the claims. Further, no component described herein is required for the practice of the disclosure unless expressly described as essential or critical.

Those skilled in the art having read this disclosure will recognize that changes and modifications may be made to the embodiments without departing from the scope of the present disclosure. It should be appreciated that the particular implementations shown and described herein may be illustrative of the disclosure and its best mode and may be not intended to otherwise limit the scope of the present disclosure in any way. Other variations may be within the scope of the following claims.

While this specification contains many specifics, these should not be construed as limitations on the scope of the disclosure or of what can be claimed, but rather as descriptions of features specific to particular implementations of the disclosure. Headings herein may be not intended to limit the disclosure, embodiments of the disclosure or other matter disclosed under the headings.

Herein, the term “or” may be intended to be inclusive, wherein “A or B” includes A or B and also includes both A and B. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D. Additionally, the symbol “/” between words represents the term “and/or.”

The terminology used herein is for the purpose of describing particular embodiments only and is not intended to be limiting of the disclosure. As used herein, the singular forms “a,” “an,” and “the” may be intended to include the plural forms as well, unless the context clearly indicates otherwise. The ellipsis symbol “...” represents the series of those items.

The corresponding structures, materials, acts, and equivalents of all means or step plus function elements in the claims below may be intended to include any structure, material, or act for performing the function in combination with other claimed elements as specifically claimed.

As used herein with respect to an identified property (e.g., amount, alignment, etc.), “substantially” refers to a degree of deviation that is sufficiently small so as to not measurably detract from the identified property. The exact degree of deviation allowable may in some cases depend on the specific context. As used herein with respect to an identified property (e.g., amount, alignment, etc.), the term “similar” may refer to values that are within a particular offset or percentage of each other (e.g., 1%, 2%, 5%, 10%, etc.).

As used herein, the term “about,” when referring to a value or to an amount of an angle, distance, mass, weight, time, volume, concentration, or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Unless defined otherwise, all technical and scientific terms (such as acronyms used for chemical elements within the periodic table) used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

What is claimed is:

1. A sorting nozzle assembly for sorting objects from a surface of a moving conveyor belt using a gaseous media, the sorting nozzle assembly comprising an array of N (where N>1) nozzles each configured to project the gaseous media in controlled bursts towards a selected object moving past the array on the conveyor belt, wherein a first subset of the array is configured to project a first controlled burst of the gaseous media from one or more of the N nozzles towards a bottom edge of the selected object to promote a lifting of the selected object from the surface of the conveyor belt.

2. The sorting nozzle assembly as recited in claim 1, wherein a second subset of the array is configured to project a second controlled burst of the gaseous media from one or more of the N nozzles towards the selected object to promote a displacement of the selected object from the surface of the conveyor belt towards a distal edge of the conveyor belt.

3. The sorting nozzle assembly as recited in claim 2, wherein a third subset of the array is configured to project a third controlled burst of the gaseous media from one or more of the N nozzles towards the selected object to eject the selected object from the surface of the conveyor belt, wherein the third controlled burst is timed to initiate subsequent to initiation of the second controlled burst.

4. The sorting nozzle assembly as recited in claim 1, wherein a first nozzle of the first subset is configured to project the first controlled burst of the gaseous media, and wherein a second nozzle of the first subset is configured to project a second controlled burst of the gaseous media towards the selected object, wherein the first nozzle is positioned below the second nozzle within the array, and wherein the first nozzle is configured to project the first controlled burst at a first angle relative to the surface of the conveyor belt, and wherein the second nozzle is configured to project the second controlled burst at a second angle relative to the surface of the conveyor belt, wherein the second angle is greater than the first angle.

5. The sorting nozzle assembly as recited in claim 4, wherein the first and second nozzles are configured to simultaneously project the first and second controlled bursts.

6. The sorting nozzle assembly as recited in claim 3, wherein a third nozzle of the third subset is configured to project the third controlled burst at a third angle relative to the surface of the conveyor belt, wherein the third angle is less than the second angle.

7. The sorting nozzle assembly as recited in claim 2, wherein a first nozzle of the second subset is configured to project a controlled burst in a direction parallel to the surface of the conveyor belt.

8. A material handling system comprising:
a conveyor belt configured to transport material pieces deposited onto a surface of the conveyor belt; and
a nozzle assembly positioned adjacent to a proximal side of the conveyor belt, the nozzle assembly comprising N (where N>1) nozzles each configured to controllably project a gaseous media from an orifice in a specified direction towards a target location relative to the surface of the conveyor belt in order to eject selected ones of the material pieces from a distal side of the surface of the conveyor belt,
wherein a first one of the N nozzles is configured to project the gaseous media towards a first target location along a first vector,
wherein a second one of the N nozzles is configured to project the gaseous media towards a second target location along a second vector,
wherein the first and second target locations are positioned so that the gaseous media projected from the first and second ones of the N nozzles progressively displaces a selected material piece towards the distal side of the surface of the conveyor belt as the selected material piece travels past the first and second ones of the N nozzles in succession.

9. The material handling system as recited in claim 8, wherein the first and second vectors are aligned substantially parallel to each other transversely across the surface of the conveyor belt from the proximal side to the distal side, wherein the first target location is positioned a first height D₁ above the surface of the conveyor belt at a first distance Y₁ from the first one of the N nozzles in a transverse direction across the conveyor belt, wherein the second target location is positioned a second height D₂ above the surface of the conveyor belt at a second distance Y₂ from the second one of the N nozzles in the transverse direction across the conveyor belt, wherein the second distance Y₂ is greater than the first distance Y₁.

10. The material handling system as recited in claim 9, wherein the first height D₁ is substantially equal to the second height D₂.

11. The material handling system as recited in claim 8, wherein the first vector is aligned at a first angle relative to the surface of the conveyor belt, wherein the second vector is aligned at a second angle relative to the surface of the conveyor belt, wherein the second angle is less than the first angle.

12. The material handling system as recited in claim 11, wherein the first vector represents a centerline of the gaseous media projected from the first one of the N nozzles, and wherein the second vector represents a centerline of the gaseous media projected from the second one of the N nozzles.

13. The material handling system as recited in claim 8, wherein a third one of the N nozzles is configured to project the gaseous media towards a third target location along a third vector, wherein the first, second, and third target locations are positioned so that the gaseous media projected from the first, second, and third ones of the N nozzles progressively displaces a selected material piece towards the distal side of the surface of the conveyor belt as the selected material piece travels past the first, second, and third ones of the N nozzles in succession,
wherein the first, second, and third vectors are aligned substantially parallel to each other transversely across the surface of the conveyor belt from the proximal side to the distal side, wherein the third target location is positioned a third height D₃ above the surface of the conveyor belt at a third distance Y₃ from the third one of the N nozzles in a transverse direction across the conveyor belt, wherein the third distance Y₃ is greater than the second distance Y₂,
wherein the third vector is aligned at a third angle relative to the surface of the conveyor belt, wherein the third angle is less than the second angle.

14. The material handling system as recited in claim 8, wherein the N nozzles are arranged in an array comprising upper and lower rows of nozzles, wherein the first and second ones of the N nozzles are positioned in the upper row of the array,
wherein a third one of the N nozzles is positioned in the lower row of the array beneath the second one of the N nozzles, wherein the third one of the N nozzles is configured to project the gaseous media along a third vector that is substantially parallel to the surface of the conveyor belt.

15. The material handling system as recited in claim 14, wherein a fourth one of the N nozzles is positioned in the lower row of the array beneath the first one of the N nozzles, wherein the fourth one of the N nozzles is configured to project the gaseous media at a fourth target location along a fourth vector, wherein the fourth target location is the surface of the conveyor belt near the first target location.

16. The material handling system as recited in claim 13, wherein the N nozzles are arranged in an array comprising upper and lower rows of nozzles, wherein the first, second, and third ones of the N nozzles are positioned in the upper row of the array,
wherein a fourth one of the N nozzles is positioned in the lower row of the array beneath the second one of the N nozzles, wherein the fourth one of the N nozzles is configured to project the gaseous media along a fourth vector that is substantially parallel to the surface of the conveyor belt,
wherein a fifth one of the N nozzles is positioned in the lower row of the array beneath the third one of the N nozzles, wherein the fifth one of the N nozzles is configured to project the gaseous media along a fifth vector that is substantially parallel to the surface of the conveyor belt.

17. The material handling system as recited in claim 16, wherein a sixth one of the N nozzles is positioned in the lower row of the array beneath the first one of the N nozzles, wherein the sixth one of the N nozzles is configured to project the gaseous media at a sixth target location along a sixth vector, wherein the sixth target location is the surface of the conveyor belt substantially beneath the first target location, wherein each vector represents an approximate centerline of the gaseous media projected from its respective nozzle.
